(19) United States
(12) Patent Application Publication
(10) Pub. No.: US 2006/0222230 A1
(43) Pub. Date: Oct. 5, 2006

(54) Genuine note determination system and operation method thereof, value media processing device and operation method thereof, flow line control server and flow line control method, surveillance control server and surveillance control method, hall control server and hall control method, data center server and operation method thereof, and program

(75) Inventor: Takamitsu Ishikawa, Ichinomiya-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto (JP)

(21) Appl. No.: 11/392,155

(22) Filed: Mar. 29, 2006

(30) Foreign Application Priority Data
Mar. 31, 2005 (JP) 2005-102297

(51) Int. Cl. G06K 9/00; G05B 19/00

(52) U.S. Cl. 382/135; 340/5.1

(57) ABSTRACT

In surveillance for the use of forged notes based on a genuine note determination program, and rapid updating of the genuine note determination programs, a dispensing machine receives a note inserted by a player, the characteristic information of the inserted note is extracted, and based on the characteristic information it is determined whether the note is genuine or not genuine. A flow line control server acquires the position of the player as position information, and the acquired position information is accumulated for each player. When the result of the genuine note determination is that the note is neither genuine nor not genuine, a surveillance control server controls a camera to take an image of the area corresponding to the position information of the player that inserted the note from among the position information accumulated in the flow line control server. The machine can be applied to a forged note determination system.

### BACKGROUND OF THE INVENTION

1. Field of the Invention

The present invention relates to a genuine note determination system and operation method thereof, a value media processing device and operation method thereof, a flow line control server and flow line control method, a surveillance control server and surveillance control method, a hall control server and hall control method, a data center server and operation method thereof, and a program. More particularly the present invention relates to a genuine note determination system and operation method thereof, a value media processing device and operation method thereof, a flow line control server and flow line control method, a surveillance control server and surveillance control method, a hall control server and hall control method, a data center server and operation method thereof, and a program to prevent the use of forged notes.

2. Description of the Related Art

Value media processing devices such as machines selling prepaid cards or dispensing change are becoming more common. Usually a bank note is inserted in the value media processing device, the value of the inserted bank note is determined, a specific prepaid card is sold, and change is discharged. In particular, many value media processing devices are installed in amusement halls such as pachinko halls or pachislot halls. Furthermore, in amusement halls ball dispensing machines (or medal dispensing machines) are used.

There appears to be no end to losses due illegal use of forged bank notes in these value media processing devices. To prevent the use of forged notes a scheme in which notes inserted into several ball dispensing machines are examined by an examination device at one location, and if a forged note is used the location of the ball dispensing machine is identified (for example, see Japanese Patent Application Laid-open No. 2000-70536).

### SUMMARY OF THE INVENTION

However, in the method of examining at one location using an examining device, it is not possible to determine whether a note is genuine or a forgery until it has been brought to the examination device at one location. Therefore, there is a concern that if an illegal player moves immediately after using a forged note it will not be possible to identify the illegal player and sufficiently guard against illegal acts.

Therefore to resist this illegal use a surveillance system has been proposed in which value media processing devices are monitored by several surveillance cameras. However, although some conventional surveillance systems using imaging are automated, after determining whether a note is genuine or a forgery they can only receive a note if it is determined that a note is genuine (a real banknote) or return the note if it is determined that the note is a forgery (not a real banknote). Even when a forged note is inserted it is not possible to issue a warning on the spot. The characteristic information used in determining whether a note is genuine or a forgery for skillfully forged notes is frequently near the threshold values used in the determination process. Therefore it is frequently difficult to determine immediately whether a note is genuine or a forgery. As a result, the first time it is discovered that a forged note has been used is after the staff have collected the notes accumulated in a value media processing device and closely examined the note. Therefore it is difficult to find and apprehend players that use forged notes.

Furthermore, this type of illegal act frequently occurs several times in different amusement halls having specific value media processing devices, and by the same method of operation and around the same time in an amusement hall having specific value media processing devices. The background to targeting a specific value media processing device is that within the same type of value media processing device the determination data (data for determining whether the a note is genuine or a forgery) is the same. Although the data is revised and improved as a note circulates, the fact is that determination data corresponding to the latest forged notes is not always immediately available. Therefore, unless a player that used a forged note is immediately apprehended or at least identified, there is a concern that these illegal acts will be repeated over a wide area.

With the foregoing in view, it is an object of the present invention to accurately take an image and record the illegal player that used a forged note in an amusement hall, and to dynamically modify the data used in determining whether a note is genuine or a forgery in accordance with the occurrence of forged notes (also including notes that may be forgeries).

The genuine note determination system according to the present invention includes a first information processing device that distinguishes genuine notes, a second information processing device that accumulates position information for players that enter an amusement hall, and a third information processing device that takes images of players based on position information of the second information processing device, and includes note insertion means that receives notes inserted by players; extraction means that extracts characteristic information of the note inserted in the note insertion means; genuine note determination means that determines whether the note is genuine or whether the note is not genuine based on the characteristic information; position information acquisition means that acquires the position of the players as position information; accumulation means that accumulates the position information acquired by the position information acquisition means for each player; and imaging means that takes images of the area corresponding to the position information of the player that inserted the note in the note insertion means from among the position information accumulated by the accumulation means when the determination result of the genuine note determination means is that a note is neither genuine nor not genuine.

The first information processing device that distinguishes genuine notes can be a value media processing device. The second information processing device that accumulates position information for players that enter an amusement hall can be a flow line control server. The third information processing device that takes images of players based on position information of the second information processing device can be a surveillance control server.

The value media processing device may include note insertion means that receives notes inserted by players; extraction means that extracts characteristic information of the note inserted in the note insertion means; and genuine note determination means that determines whether a note is genuine or not genuine. The flow line control server may include position information acquisition means that acquires the position of players as position information; and accumulation means that accumulates position information acquired by the position information acquisition means for each player. The surveillance control server may include imaging means that takes images of the area corresponding to the position information of a player that inserted a note from among the position information accumulated in the accumulation means when the determination result of the genuine note determination means is that the note is neither genuine nor not genuine.

The genuine note determination means can determine whether the note is genuine or whether the note is not genuine based on a comparison of the characteristic information with criterion information that indicates whether a note is genuine or not genuine.

The genuine note determination system may further include a fourth information processing device that generates update information for the criterion information.

The fourth information processing device may be a hall control server that includes update determination means that determines whether to update criterion information based on the characteristic information extracted by the extraction means and images taken by the imaging means; and update criterion information generation means that generates updated criterion information by updating the criterion information based on the characteristic information. The value media processing device can further include update means that updates the criterion information to the updated criterion information.

A fifth information processing device that accumulates characteristic information extracted by the extraction means of a plurality of genuine note determination systems and images taken by the image taking means may also be included.

The fifth information processing device may be a data center server, including accumulation means that accumulates characteristic information extracted from notes in a plurality of genuine note determination systems and images taken by the imaging means; and accumulation determination means that determines whether the characteristic information extracted by the extraction means and the images taken by the imaging means of the genuine note determination system are accumulated in the accumulation means. Based on the determination result of the accumulation determination means for the characteristic information extracted by the extraction means and the images taken by the imaging means, the update determination means can determine whether to update the criterion information or not.

When the number of times the accumulation determination means determines that characteristic information extracted by the extraction means and the images taken by the imaging means are not registered within a predetermined period of time is greater than a predetermined number, the update determination means can decide to update the criterion information.

When the criterion information is updated to updated criterion information by the update means, the accumulation means can accumulate the characteristic information extracted by the extraction means, the images taken by the imaging means, and the updated criterion information.

When the accumulation determination means determines that the characteristic information extracted by the extraction means and images taken by the imaging means of the genuine note determination system have already been accumulated by the accumulation means, the update means can update the update criterion information, as the criterion information, corresponding to the characteristic information extracted by the extraction means and the images taken by the imaging means of the genuine note determination system that are determined to be already accumulated.

The genuine note determination method of the genuine note determination system according to the present invention includes a note inserting step of receiving a note inserted by a player; an extracting step of extracting characteristic information for the note inserted in the note inserting step; a genuine note determining step of determining whether the note is genuine or whether the note is not genuine based on the characteristic information; a position information acquiring step of acquiring the position of players as position information; an accumulating step of accumulating position information acquired in the position information acquiring step for each player; and an image taking step of taking images of the area corresponding to the position information of the player that inserted a note in the note inserting step from among the position information accumulated in the accumulating step, when the result in the genuine note determination step is neither that the note is genuine nor that the note is not genuine.

A first program that is executed on a computer according to the present invention includes a note inserting step of receiving a note inserted by a player; an extracting step of extracting characteristic information for the note inserted in the note inserting step; a genuine note determining step of determining whether the note is genuine or whether the note is not genuine based on the characteristic information; a position information acquiring step of acquiring the position of players as position information; an accumulating step of accumulating position information acquired in the position information acquiring step for each player; and an image taking step of taking images of the area corresponding to the position information of the player that inserted a note in the note inserting step from among the position information accumulated in the accumulating step, when the result in the genuine note determination step is neither that the note is genuine nor that the note is not genuine.

The value media processing device according to the present invention includes note insertion means that receives notes inserted by players; extraction means that extracts characteristic information of the note inserted in the note insertion means; and genuine note determination means that determines whether the inserted note is genuine or whether the note is not genuine based on the characteristic information.

The method of operating a value media processing device according to the present invention includes a note inserting step of receiving a note inserted by a player; an extraction step of extracting characteristic information of the note inserted in the note inserting step; and a genuine note determination step of determining whether the note is genuine or whether the note is not genuine based on the characteristic information.

A second program according to the present invention that is executed on a computer includes a note inserting step of receiving a note inserted by a player; an extraction step of extracting characteristic information of the note inserted in the note inserting step; and a genuine note determination step of determining whether the note is genuine or whether the note is not genuine based on the characteristic information.

A flow line control server according to the present invention includes position information acquisition means that acquires the position of players as position information; and accumulation means that accumulates position information acquired by the position information acquisition means for each player.

A flow line control method for a flow line control server according to the present invention includes a position information acquiring step of acquiring the position of players as position information; and an accumulating step of accumulating the position information acquired in the position information acquiring step for each player.

A third program according to the present invention that is executed on a computer includes a position information acquiring step of acquiring the position of players as position information; and an accumulating step of accumulating the position information acquired in the position information acquiring step for each player.

A surveillance control server according to the present invention includes imaging means that takes images of the area corresponding to the position information of a player when a note inserted by the player is neither genuine nor not genuine based on characteristic information of the note.

A surveillance control method for a surveillance control server according to the present invention includes an image taking step of taking images of the area corresponding to the position information of a player when a note inserted by the player is neither genuine nor not genuine based on characteristic information of the note.

A fourth program according to the present invention that is executed on a computer includes an image taking step of taking images of the area corresponding to the position information of a player when a note inserted by the player is neither genuine nor not genuine based on characteristic information of the note.

A hall control server according to the present invention includes update determination means that determines whether to update criterion information that indicates whether the characteristic information of a note inserted by a player is genuine or not genuine based on the characteristic information of the note inserted by the player and images taken of the player; and update criterion information generation means that generates updated criterion information by updating the criterion information based on the characteristic information.

A hall control method for a hall control server according to the present invention includes an update determining step of determining whether to update criterion information that indicates whether the characteristic information of a note is genuine or not genuine based on the characteristic information of the note inserted by the player and images taken of the player; and an update criterion information generating step of generating updated criterion information by updating the criterion information based on the characteristic information.

A fifth program according to the present invention that is executed on a computer includes an update determining step of determining whether to update criterion information that indicates whether the characteristic information of a note is genuine or not genuine based on the characteristic information of the note inserted by the player and images taken of the player; and an update criterion information generating step of generating updated criterion information by updating the criterion information based on the characteristic information.

A data center server according to the present invention includes accumulation means that accumulates characteristic information extracted from notes in a plurality of genuine note determination systems and images taken of players that inserted the notes; and accumulation determination means that determines whether the characteristic information extracted from the note and the images taken of the player are accumulated in the accumulation means.

A method of operating a data center server according to the present invention includes an accumulating step of accumulating characteristic information extracted from notes in a plurality of genuine note determination systems and images taken of players that inserted the notes; and an accumulation determination step of determining whether the characteristic information extracted from the note and the images taken of the player are accumulated in the accumulation means.

A sixth program according to the present invention that is executed on a computer includes an accumulating step of accumulating characteristic information extracted from notes in a plurality of genuine note determination systems and images taken of players that inserted the notes; and an accumulation determination step of determining whether the characteristic information extracted from the note and the images taken of the player are accumulated in the accumulation means.

In the genuine note determination system and method and first program according to the present information, a note inserted by a player is received, the characteristic information of the inserted note is extracted, based on the characteristic information it is determined whether the note is genuine or whether the note is not genuine, the position of the player is acquired as position information, the acquired position information is accumulated for each player, when the genuine note determination result is that the note is neither genuine nor not genuine an image is taken of the area corresponding to the position information of the player that inserted the note from among the accumulated position information.

In the value media processing device and operating method and second program according to the present invention, a note inserted by a player is received, the characteristic information of the inserted note is extracted, and based on the characteristic information it is determined whether the note is genuine or whether the note is not genuine.

In the flow line control server and flow line control method and third program according to the present invention, the position of a player is acquired as position information, and the acquired position information is accumulated for each player.

In the surveillance control server and surveillance control method and fourth program according to the present invention, an image of the area corresponding to the position information of a player is taken when the note is neither genuine nor not genuine based on the characteristic information of the note inserted by the player.

In the hall control server and hall control method and fifth program according to the present invention, based on the characteristic information of a note inserted by a player and the images taken of the player it is determined whether to update the criterion information that indicates whether the characteristic information of a note is genuine or not genuine, and updated criterion information is generated based on the characteristic information.

In the data center server and operation method and sixth program according to the present invention, characteristic information extracted from notes in a plurality of genuine note determination systems and images of players that inserted the notes are accumulated, and it is determined whether the characteristic information extracted from the notes and images taken of players are accumulated or not.

In the genuine note determination system according to the present invention, the note insertion means that receives notes inserted by players is, for example, the note insertion and return unit of a dispensing machine; the extraction means that extracts the characteristic information of inserted notes is, for example, the characteristic information extraction unit of a dispensing machine; the genuine note determination means that determines whether a note is genuine or not genuine based on the characteristic information is, for example, the genuine note determination unit of a dispensing machine; the position information acquisition means that acquires the position of a player as position information is, for example, the position information extraction unit of a flow line control server; the accumulation means that accumulates the acquired position information for each player is, for example, the position control table; the imaging means that takes images of the area corresponding to the position information of players that inserted notes from among the accumulated position information when the determination result is that the note is neither genuine nor not genuine is, for example, a camera controlled by the surveillance control server.

Also, the update determination means that determines whether to update the criterion information based on the extracted characteristic information and images taken by the imaging means is, for example, the genuine note determination program update determination unit of the hall control server; the update criterion information generation means that generates updated criterion information of the criterion information based on characteristic information is, for example, the update program generation unit of the hall control server; the update means that updates the criterion information to updated criterion information is, for example, the control unit of a dispensing machine.

In other words, the note insertion and return unit of a dispensing machine receives a note received by a player. The characteristic information extraction unit of the dispensing machine extracts the characteristic information of the inserted note. The genuine note determination unit of the dispensing machine determines whether the note is genuine or not genuine based on the characteristic information. When the genuine note determination result is that the note is neither genuine nor not genuine, the position information extraction unit of the flow line control server acquires the position of the player as position information, and the acquired position information is accumulated in a position control table for each player. Therefore, the surveillance control server controls a camera to take an image of the area corresponding to the position information of a player that inserted a note.

As a result, it is possible to obtain the characteristic information of a note that is potentially forged and an image of the player that used the note, so it is possible to deter illegal acts by the use of forged notes.

Also, the genuine note determination program update determination unit of the hall control server determines whether to update the criterion information based on the extracted characteristic information and the images taken by the imaging means. The update program generation unit of the hall control server generates updated criterion information of the criterion information based on the characteristic information, and the control unit of the dispensing machine updates the criterion information to the updated criterion information.

As a result, the criterion information for notes that are potentially forged is updated in accordance with the detection of notes that are potentially forged, so it is possible to deter the use of forged notes.

According to the present invention, it is possible to monitor for the use of forged notes and respond rapidly with updated programs.

### BRIEF DESCRIPTION OF THE DRAWINGS

FIG. 1 is a figure showing the configuration of a forged note surveillance system in an amusement hall according to an embodiment of the present invention;

FIG. 2 shows the configuration of an embodiment of an entrance stereoscopic image sensor in FIG. 1;

FIG. 3 shows the configuration of an embodiment of an playing area stereoscopic image sensor in FIG. 1;

FIG. 4 shows an arrangement example of an entrance stereoscopic image sensor, playing area stereoscopic image sensor, and cameras in FIG. 1;

FIG. 5 shows the configuration of an embodiment of the hardware of the hall control server in FIG. 1;

FIG. 6 shows the configuration of an embodiment explaining the function of the hall control server in FIG. 1;

FIG. 7 shows the configuration of an embodiment showing the function of a dispensing machine and a control device in FIG. 1;

FIG. 8 shows the configuration of an embodiment showing the function of a flow line control server in FIG. 1;

FIG. 9 shows the configuration of an embodiment showing the function of a surveillance control server in FIG. 1;

FIG. 10 shows the configuration of an embodiment showing the function of a data center server in FIG. 1;

FIG. 11 is a flowchart explaining the position control table control process;

FIG. 12 is a flowchart explaining the forged note determination process;

FIG. 13 is a figure explaining the criterion data used in the forged note determination process;

FIG. 14 is a flowchart explaining the provisionally suspect data generation process;

FIG. 15 is a flowchart explaining the update determination process;

FIG. 16 is a flowchart explaining the genuine note determination program update process; and

FIG. 17 is a flowchart explaining the genuine note determination program update process.

### DESCRIPTION OF THE PREFERRED EMBODIMENTS

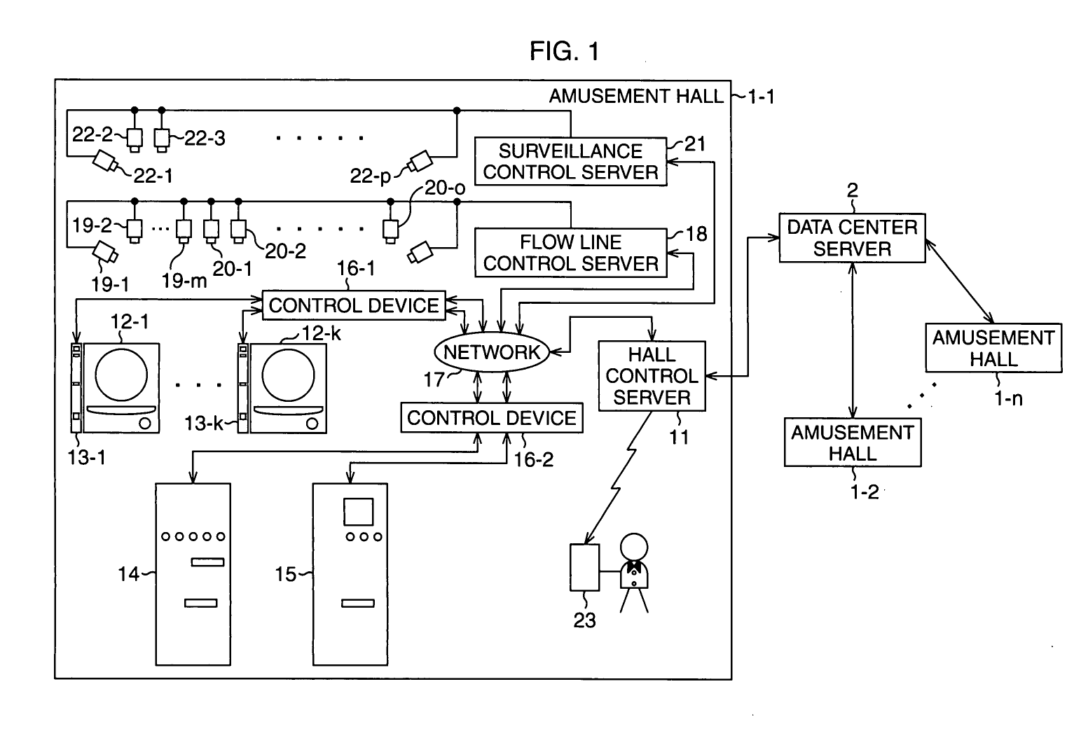

FIG. 1 shows the configuration of an amusement hall forged note surveillance system according to an embodiment of the present invention.

A data center server 2 accumulates suspect data corresponding to forged notes supplied by a plurality of amusement halls 1-1 through 1-n and genuine note determination programs. Also, when the amusement halls 1-1 through 1-n raise an inquiry with the data center server 2 regarding provisionally suspect data, the data center server 2 checks the accumulated suspect data, notifies the inquirer of the result of the check, and if the data is previously known the data center server 2 provides a corresponding genuine note determination program. Unless there is a particular need to distinguish amusement halls 1-1 through 1-n, the description amusement hall 1 will be simply used, and the rest of the configuration will be referred to in the same way.

A hall control server 11 has total control over forged note surveillance processing in amusement hall 1. A plurality of dispensing machines 13-1 through 13-k provided on game machines 12-1 through 12-k, a prepaid card sales machine 14, and a change machine 15 are connected to the hall control server 11 via a network 17 such as the internet. When a forged note is detected in any of the dispensing machines 13-1 through 13-k provided on game machines 12-1 through 12-k, the prepaid card sales machine 14, or the change machine 15, a flow line control server 18 is controlled, the location of the player that used the forged note is confirmed, an image is taken of the area around the corresponding location by the action of a surveillance control server 21, and a warning that a forged note has been used is issued to a mobile terminal 23 in the possession of the staff of the amusement hall 1.

Furthermore, the hall control server 11 generates provisionally suspect data based on the characteristic information of the detected forged note and the images taken, and raises an inquiry with the data center server 2. If the provisionally suspect data that is the subject of the inquiry has not been registered, the hall control server 11 generates an update program for the genuine note determination program for the dispensing machines 13-1 through 13-k, prepaid card sales machine 14, and change machine 15, updates the programs, and provides the update result to the data center server 2. Also, if the provisionally suspect data has already been registered, an update program for the genuine note determination program is obtained from the data center server 2, and the program is updated.

When a note or a prepaid card is inserted into a dispensing machine 13, balls or medals or similar are dispensed to the game machine 12 according to the amount inserted. More specifically, when a note is inserted into a dispensing machine 13, the dispensing machine 13 determines whether the inserted note is genuine. If the note is a genuine note, or if it is not possible to determine whether the note is genuine or not genuine, balls or medals are dispensed according to the amount inserted. Also, if it is determined that the inserted note is a forgery, the dispensing machine 13 returns the inserted note, and supplies the characteristic information of the note used in determining whether it is a genuine note or not and the machine data, to the hall control server 11 via a control device 16-1. Also, if a prepaid card is inserted in the dispensing machine 13, the same process is executed as if a note had been inserted, according to the amount of money registered in the prepaid card.

Furthermore, when the hall control server 11 provides the dispensing machines 13 with an update program for the genuine note determination program, the genuine note determination program is updated to the new updated program.

The prepaid card sales machine 14 issues prepaid cards on which information is recorded corresponding to the amount of money inserted. This prepaid card can be used in the same way as notes by inserting the card into the dispensing machine 13 as described above.

More specifically, when a note is inserted into a prepaid card sales machine 14, the prepaid card sales machine 14 determines whether the inserted note is genuine or not. If the note is a genuine note, or if it is not possible to determine whether it is genuine or not, a prepaid card is issued according to the amount inserted. Also, if the prepaid card sales machine 14 determines that the inserted note is not genuine the inserted note is returned, and the characteristic information of the note used in determining whether the note is genuine or not genuine and the machine data are supplied to the hall control server 11 via a control device 16-2.

Furthermore, when the hall control server 11 provides the prepaid card sales machine 14 with an update program for the genuine note determination program via the control device 16-2, the genuine note determination program is updated to the new updated program.

The change machine 15 provides change according to the value of the note inserted.

More specifically, when a note is inserted into a change machine 15, the change machine 15 determines whether the inserted note is genuine or not. If the note is a genuine note, or if it is not possible to determine whether it is genuine or not, change is provided for the note inserted. Also, if the change machine 15 determines that the inserted note is not genuine the inserted note is returned, and the characteristic information of the note used in determining whether the note is genuine or not genuine and the machine data are supplied to the hall control server 11 via a control device 16-2.

Furthermore, when the hall control server 11 provides the change machine 15 with an update program for the genuine note determination program via the control device 16-2, the genuine note determination program is updated to the new updated program.

The genuine note determination programs of the dispensing machines 13, the prepaid card sales machine 14, and the change machine 15 are all the same, and when the program is updated in amusement hall 1, each genuine note determination program is updated using the same update program.

The control device 16 encrypts provisionally suspect data and machine data supplied from the dispensing machines 13, the prepaid card sales machine 14, and the change machine 15, and provides the encrypted data to the hall control server 1. In addition the control device 16 decrypts the encrypted update program for the genuine note determination program provided by the hall control server 11, and provides the program to the dispensing machines 13, the prepaid card sales machine 14, and the change machine 15.

The flow line control server 18 acquires position information containing a person ID provided from entrance stereoscopic image sensors 19-1 through 19-m and playing area stereoscopic image sensors 20-1 through 20-o, creates a position control table from the person ID and position information, applies a person ID to the successively provided position information of each player, and controls the information together with time information obtained. When there is an inquiry from the hall control server 11 based on machine data and time information, the flow line control server 18 searches for a person ID to identify a person that was nearby at the corresponding time, based on the position information corresponding to the machine data. In addition the current position information for the person corresponding to the person ID is read out, and provided to the hall control server 11.

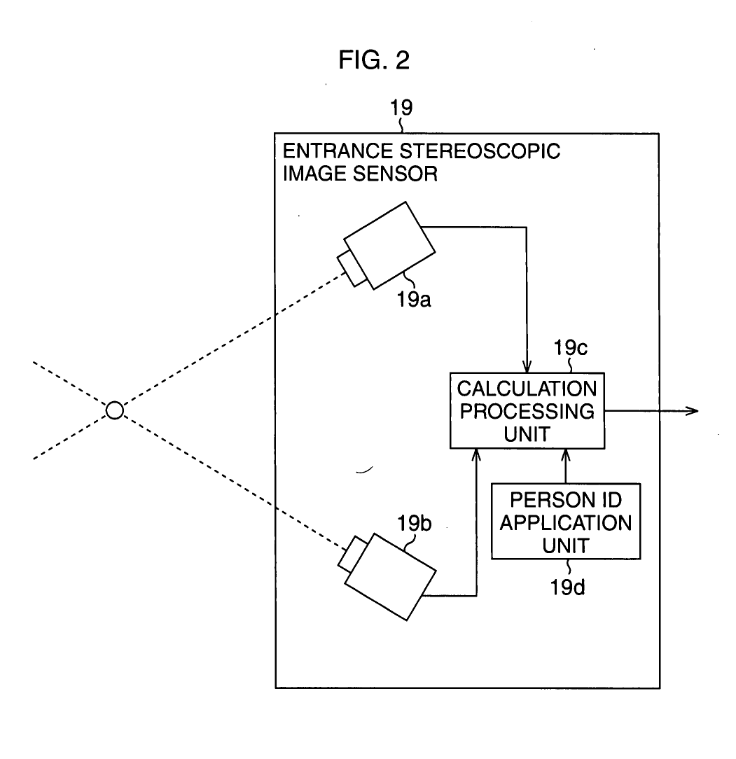

Next, a detailed description of the entrance stereoscopic image sensors 19-1 through 19-m and the playing area stereoscopic image sensors 20-1 through 20-o will be provided with reference to FIGS. 2 through 4.

The entrance stereoscopic image sensors 19-1 through 19-m and the playing area stereoscopic image sensors 20-1 through 20-o are sensors including two cameras arranged in different positions. A calculation process is carried out using the parallax of the images at two different angles obtained by taking images of the same position with two cameras arranged at different positions, to obtain the spatial position of the subject photographed, and this spatial information is provided to a person tracking server 5.

More specifically, as shown in FIG. 2, the stereoscopic image sensor 19 includes cameras 19a and 19b, that each take images of the same position and output the results to a calculation processing unit 19c. The calculation processing unit 19c obtains the three-dimensional coordinates of the spatial position of the subject taken in the images by a calculation process (a calculation process using the triangulation method) using the parallax of the images taken at different angles provided by cameras 19a and 19b. A person ID application unit 19d applies a person ID to each player that enters the hall at the entrance, and provides that information to the flow line control server 18. Also, when the player moves from the observation area the entrance stereoscopic image sensor 19 provides the person ID to the playing area stereoscopic image sensor 20 that observes the observation area near the direction that the player has moved to. The person ID application unit 19d applies a person ID only to players entering at the entrance. Person IDs are not applied to any other players. In other words, after a player has been given a person ID they are not given a new person ID.

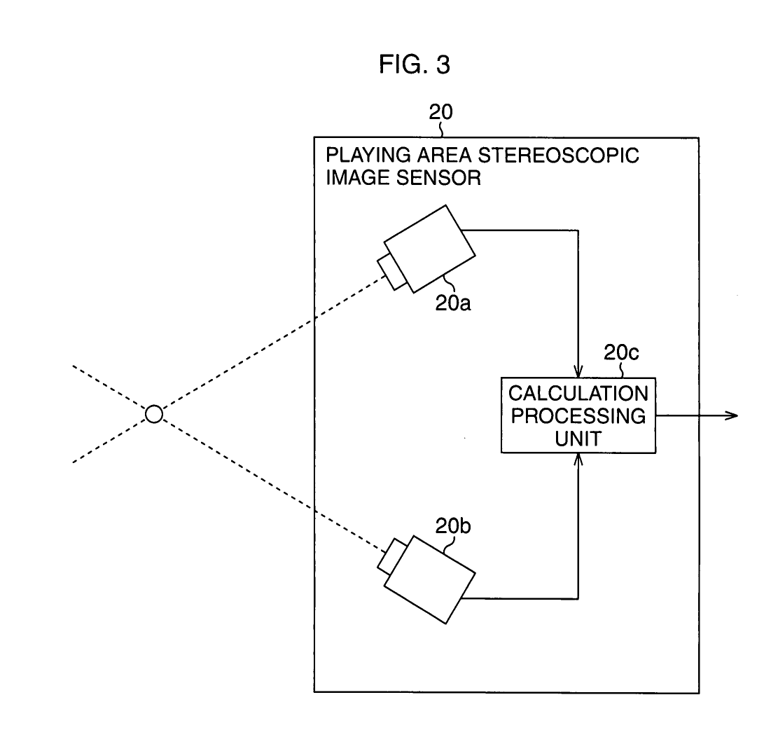

As shown in FIG. 3, the playing area stereoscopic image sensor 20 uses the same principle as the entrance stereoscopic image sensor 19, and obtains the three-dimensional coordinates of the spatial position of the subject taken in the images by a calculation process (a calculation process using the triangulation method) using the parallax of the images taken at different angles provided by cameras 20a and 20b.

The playing area stereoscopic image sensor 20 continues to use the person ID provided by the entrance stereoscopic image sensor 19 or an playing area stereoscopic image sensor 20 that detects the position of players in an adjoining area. Therefore the playing area stereoscopic image sensor 20 is not provided with a person ID application unit.

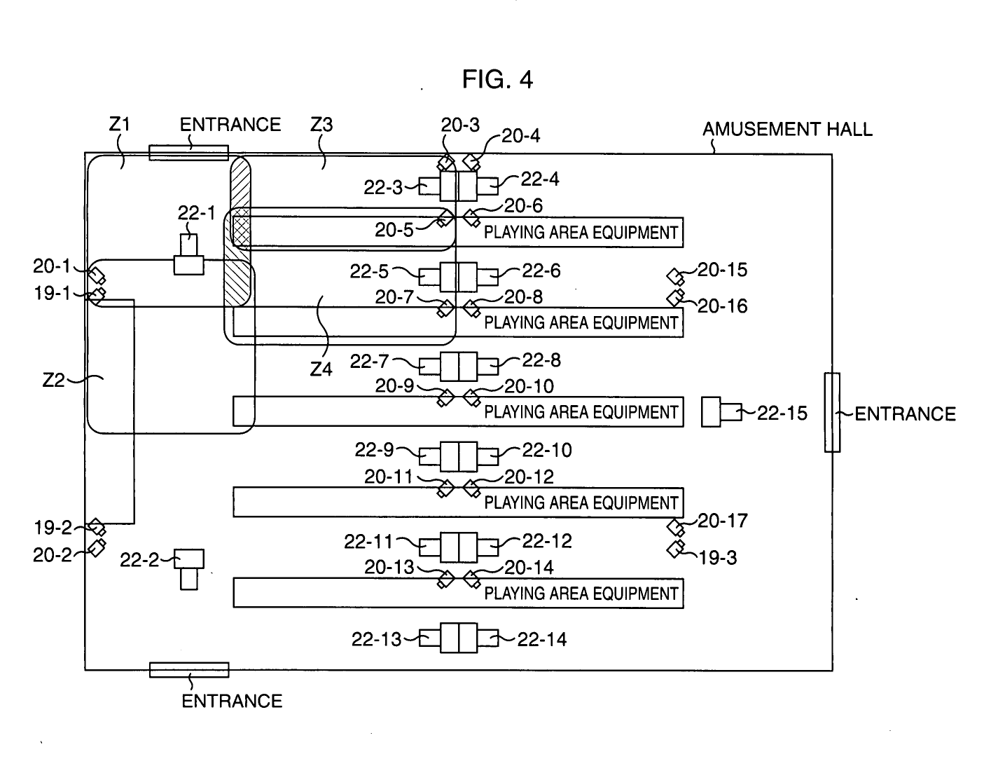

In other words, the range over which a single entrance stereoscopic image sensor 19 or playing area stereoscopic image sensor 20 can detect the spatial position of a subject within the hall is limited. Therefore, the sensors are arranged as shown in FIG. 4 for example. In FIG. 4 there are three entrances, so the entrance stereoscopic image sensors 19 are entrance stereoscopic image sensors 19-1 through 19-3. The playing area stereoscopic image sensors 20 are playing area stereoscopic sensors 20-1 through 20-17.

In this case the entrance stereoscopic image sensor 19-1 that contains the cameras 19a-1 and 19b-1 detects subjects in the area Z1, in other words, the spatial position of players in the area where players enter the amusement hall. In the same way, the playing area stereoscopic image sensor 20-1 that contains the cameras 20a-1 and 20b-1 detects subjects in the area Z2, the playing area stereoscopic image sensor 20-3 that contains the cameras 20a-3 and 20b-3 detects subjects in the area Z3, the playing area stereoscopic image sensor 20-5 that contains the cameras 20a-5 and 20b-5 detects subjects in the area Z4, each detects the spatial position information of players in their respective areas. FIG. 4 only shows the surveillance areas of entrance stereoscopic image sensor 19-1 and playing area stereoscopic image sensors 20-1, 20-3, and 20-5 as areas Z1 through Z4. Not all the surveillance areas for entrance stereoscopic image cameras 19-1 through 19-3 and playing area stereoscopic image cameras 20-1 through 20-17 are shown, although in the same way each has their own set surveillance area. Also, as shown in FIG. 4, each surveillance area is set so that there is an overlapping area as shown for example by the hatched area. FIG. 4 is a top view of an amusement hall showing an example of an arrangement of entrance stereoscopic image sensors 19, playing area stereoscopic image sensors 20, and cameras 22.

The position information of players within the respective surveillance areas of entrance stereoscopic image sensors 19 and playing area stereoscopic image sensors 20 is controlled for each person ID. However, when players move from their respective surveillance areas it could happen that it becomes impossible to carry out surveillance with the person ID attached. For this reason all the surveillance areas are set to be overlapping as described above.

In other words, for example when a player enters through the entrance in the top left of FIG. 4, the player is given the person ID=A by the entrance stereoscopic image sensor 19-1 that includes the cameras 19a-1 and 19b-1 (by the person ID application unit 19d-1). Thereafter if the player moves for example in the direction of area Z3, the entrance stereoscopic image sensor 19-1 provides the position information and person ID of the moved player to the playing area stereoscopic image sensor 20-3 that includes cameras 20a-3 and 20b-3, that monitors the adjoining surveillance area into which the player has moved. As a result, the playing area stereoscopic image sensor 20-3 can monitor the same player as the player whose position information was detected by the entrance stereoscopic image sensor 19-1 and with the same person ID.

In this way the entrance stereoscopic image sensors 19-1 through 19-3 and playing area stereoscopic image sensors 20-1 through 20-17 are configured to continuously monitor the position information of each individual player by sharing position information and person IDs. Therefore, the entrance stereoscopic image sensors 19-1 through 19-3 monitor the area near the entrances, and apply new person IDs to newly arrived players. However, the other playing area stereoscopic image sensors 20-1 through 20-17 are provided with the person IDs from the entrance stereoscopic image sensors 19 in the manner of a relay. In this embodiment the example of processing by taking into consideration the parallax between images taken by two cameras at different angles has been explained for entrance stereoscopic image sensors 19 and playing area stereoscopic image sensors 20. However, the configuration can be one in which the spatial position of the subject can be obtained taking parallax into account, so if the number of cameras at different angles is further increased, the spatial coordinates can be obtained by processing that takes in to account their respective parallax. Also, in the example in FIG. 4 an explanation has been provided for the case of a total of 20 entrance stereoscopic image sensors 19 and playing area stereoscopic image sensors 20. However, the surveillance areas can be changed and a different number of sensors may be installed. Furthermore, the function of detecting the position of players is not limited to entrance stereoscopic image sensors 19 and playing area stereoscopic image sensors 20. Any method used to determine the position of the players may be used.

Based on instructions to take images from the hall control server 11, the surveillance control server 21 operates corresponding cameras 22-1 through 22-p, takes images of the required area, and provides the image data to the hall control server 11.

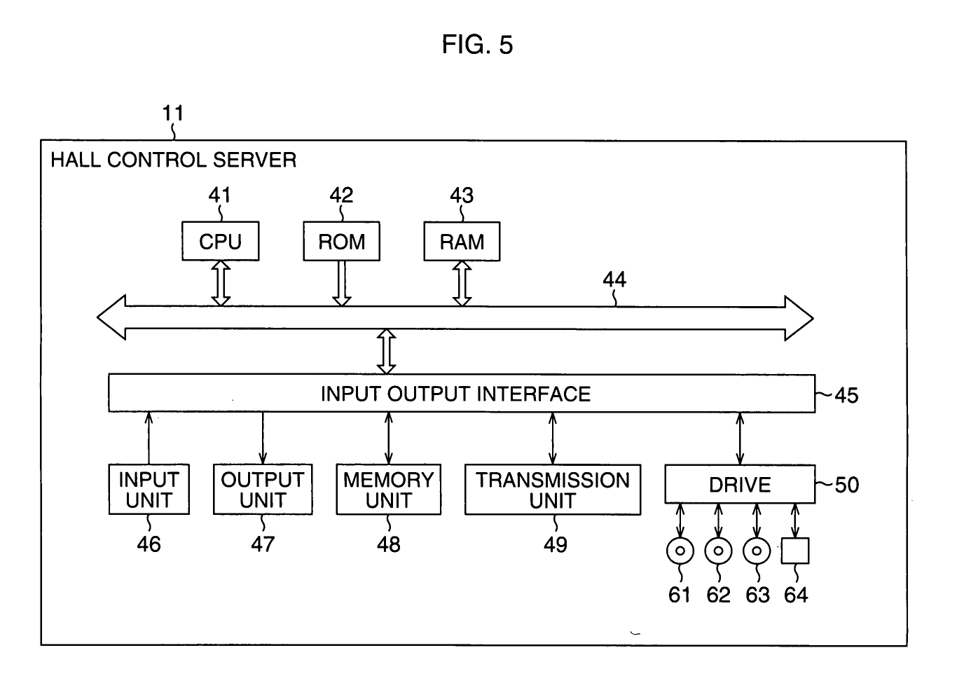

Next the configuration of the hardware of the hall control server 11 according to the preferred embodiment is explained by reference to FIG. 5. A central processing unit (CPU) 41 executes all types of processes in accordance with programs recorded on a read only memory (ROM) 42 or a memory unit 48. Programs being executed by the CPU 41 or data is recorded as required on a random access memory (RAM) 43. The CPU 41, ROM 42, and RAM 43 are mutually connected via a bus 44.

The CPU 41 is also connected via the bus 44 to an input output interface 45. The input output interface 45 is connected to an input unit 46 that includes a keyboard, mouse, microphone, and similar, an output unit 47 that includes a display, speaker, and similar. The CPU 41 executes many types of process in accordance with instructions input from the input unit 46. Then the CPU 41 outputs the image or sound or similar obtained as a result of the process from the output unit 47.

The memory unit 48 connected to the input output interface 45 can be a hard disk for example, on which programs executed by the CPU 41 or many types of data are recorded.

When a magnetic disk 61, an optical disk 62, a magneto optical disk 63, or a semiconductor memory 64 is attached to a drive unit 50 connected to the input output interface 45 and driven, programs or data recorded on these devices can be acquired. When necessary, the programs and data acquired can be transferred to the memory unit 48 and recorded.

The hardware configuration of the data center server 2, the flow line control server 18, and the surveillance control server 21 is similar to that of the hall control server 11, so their explanation is omitted.

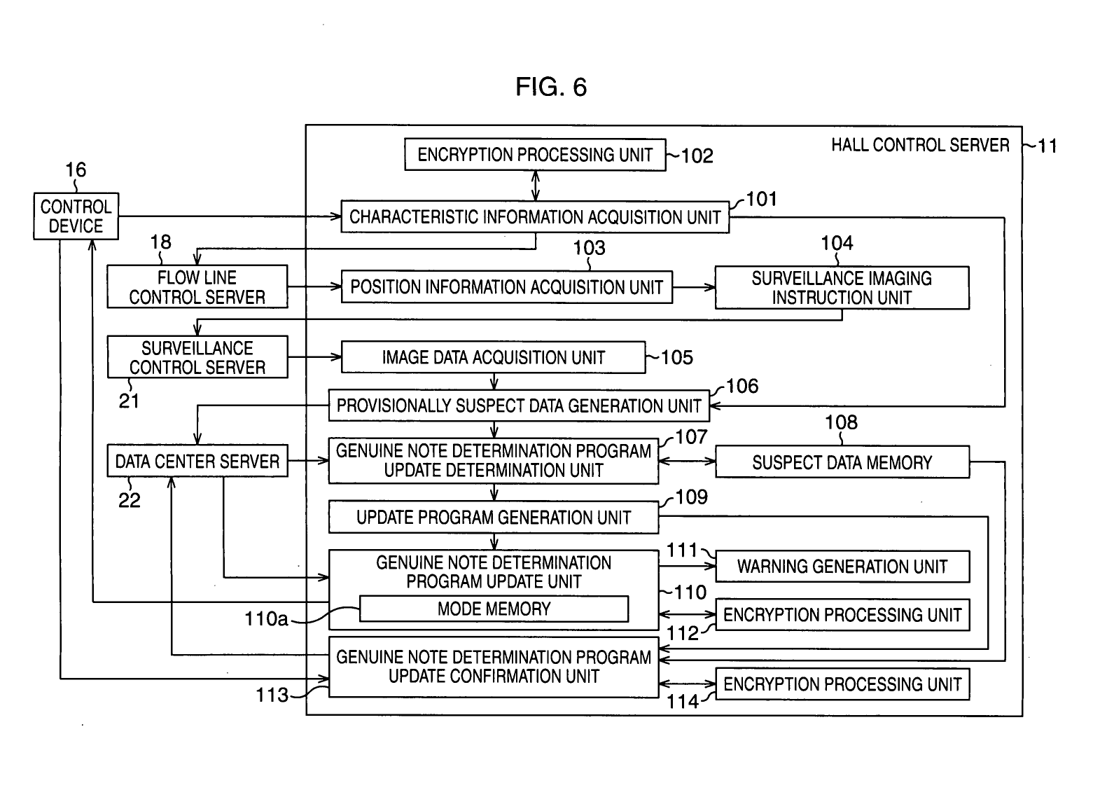

Next the configuration of the function of the hall control server 11 according to an embodiment is explained with reference to FIG. 6.

A characteristic information acquisition unit 101 acquires encrypted characteristic information of notes used in the genuine note determination process supplied from the dispensing machines 13, prepaid card sales machine 14, and change machine 15 when it is not possible to determine whether a note is genuine or not genuine by the genuine note determination process. The characteristic information includes machine data (machine number of the game machine 12 to which the dispensing machine 13 is provided: position information) to identify a dispensing machine 13 or information to identify the position of a prepaid card sales machine 14 or a change machine 15).

The characteristic information acquisition unit 101 decrypts the encrypted characteristic information by controlling an encryption processing unit 102, and provides the information indicating the installation position to the flow line control server 18, and provides the characteristic information to a provisionally suspect data generation unit 106.

A position information acquisition unit 103 acquires position information from the flow line control server 18 on persons that have used notes for which it has not been possible to determine that they are genuine, based on information indicating the installation position of a dispensing machine 13, a prepaid card sales machine 14, or a change machine 15 provided by the characteristic information acquisition unit 101, and provides the information to a surveillance imaging instruction unit 104. The method by which the flow line control server 18 identifies the position information of the person that has used a note based on information indicating the installation location of a dispensing machine 13, a prepaid card sales machine 14, or a change machine 15 is explained in detail later. Also, hereafter notes used by a player that have been determined to be not genuine or that cannot be determined to be either genuine or not genuine by the genuine note determination process are called suspect notes.

The surveillance imaging instruction unit 104 provides a surveillance imaging instruction to take an image of the person that used a suspect note together with person position information to the surveillance control server 21. An image data acquisition unit 105 acquires image data for the person that used a suspect note provided by the surveillance control server 21, based on surveillance imaging instructions, and provides the image data to the provisionally suspect data generation unit 106.

The provisionally suspect data generation unit 106 combines image data for a person that used a suspect note provided by the image data acquisition unit 105 and suspect note characteristic information provided by the characteristic information acquisition unit 101 to generate provisionally suspect data. The provisionally suspect data generation unit 106 provides this data to the data center server 2 and a genuine note determination program update determination unit 107.

When there is new suspect data that has not yet been reported by other amusement halls 1, based on determination results received from the data center server 2, based on provisionally suspect data, the genuine note determination program update determination unit 107 regards this data as suspect data, and stores the data in a suspect data memory 108. Furthermore, if provisionally suspect data that has not been reported by other amusement halls 1 arises a predetermined number of times or more within a predetermined period of time, the genuine note determination program update determination unit 107 instructs an update program generation unit 109 to generate an update program for the genuine note determination program taking the suspect data into consideration. At this time the genuine note determination program update determination unit 107 provides the combined suspect data.

The update program generation unit 109 generates an update program for the suspect data of the genuine note determination program, and provides the update program to a genuine note determination program update unit 110 and a genuine note determination program update confirmation unit 113. The action of the genuine note determination program update unit 110 depends upon whether the update mode of the genuine note determination program stored in a mode memory 110a is manual or automatic. For example, if the update mode is manual and a new update program is provided, the genuine note determination program update unit 110 controls a warning generation unit 111, and the fact that an update program has been generated is notified to the mobile terminal 23 in the possession of the staff of the amusement hall 1. Furthermore, when the staff instructs the update in response to the notification, the genuine note determination program update unit 110 controls an encryption processing unit 112, the update program is encrypted and provided to the dispensing machines 13, the prepaid card sales machine 14, and the change machine 15 via the control device 16.

On the other hand, when the information set in the mode memory 110a is automatic update, the genuine note determination program update unit 110 does not control the warning generation unit 111, and the fact that an update program has been generated is not notified to the mobile terminal 23 in the possession of the staff. The genuine note determination program update unit 110 controls the encryption processing unit 112, the update program is encrypted and provided to the dispensing machines 13, the prepaid card sales machine 14, and the change machine 15 via the control device 16.

Also, when the data center server 2 provides an update program, the genuine note determination program update unit 110 controls the encryption processing unit 112, the update program is encrypted and provided to the dispensing machines 13, the prepaid card sales machine 14, and the change machine 15 via the control device 16 in accordance with the update mode, in the same way as when the update program generation unit 109 generates an update program.

The genuine note determination program confirmation unit 113 controls an encryption processing unit 114 to decrypt the encrypted update confirmation information transmitted when the update program has updated the genuine note determination program at the dispensing machines 13, the prepaid card sales machine 14, and the change machine 15. In addition, in accordance with the acquisition of the update confirmation information, the update program and the suspect data are provided to the data center server 2.

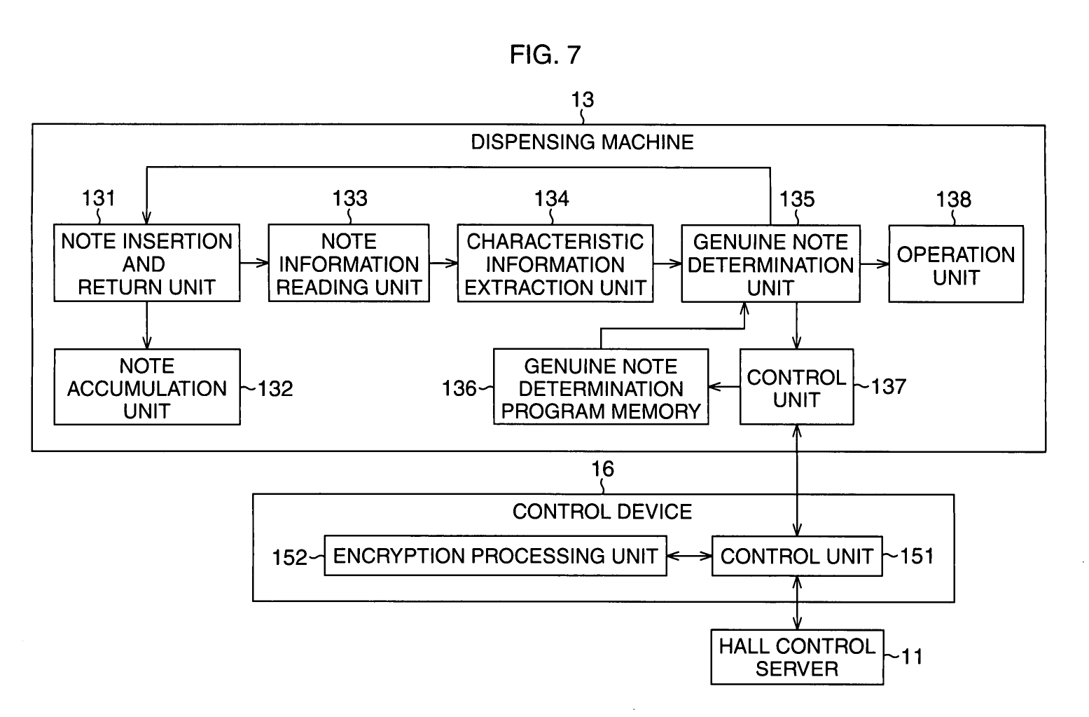

Next the configuration of the dispensing machines 13 and control device 16 according to an embodiment is explained with reference to FIG. 7.

A note insertion and return unit 131 is the position that a player inserts a note. If a genuine note determination unit 135 determines that the inserted note is genuine, or if the genuine note determination unit 135 cannot determine whether the inserted note is genuine or not, the inserted note is provided to a note accumulation unit 132, where it is accumulated with other inserted notes. If the inserted note is determined to be not genuine the inserted note is returned.

A note information reading unit 133 reads paint, watermarks, and similar printed on the inserted note using infrared sensors, magnetic sensors, and similar, and provides the information read to a characteristic information extraction unit 134. The characteristic information extraction unit 134 extracts characteristic information from the information recorded on the note provided by the note information reading unit 133 that includes infrared sensors, magnetic sensors, and similar, and provides the characteristic information to the genuine note determination unit 135.

The genuine note determination unit 135 reads the genuine note determination program recorded in a genuine note determination program memory 136, and executes a genuine note determination process based on many types of note characteristic information. If the note is determined to be genuine, or if it is not possible to determine whether the note is not genuine, the note inserted into the note insertion and return unit 131 is accumulated in the note accumulation unit 132. In addition an operation unit 138 is controlled to dispense balls or medals. Furthermore, if the note is determined to be a forgery, in other words if the inserted note is a suspect note, the genuine note determination unit 135 provides the characteristic information to a control unit 137.

Also, if the inserted note is determined to be not genuine, the genuine note determination unit 135 returns the note through the note insertion and return unit 131, and does not allow the operation unit 138 to operate.

When suspect note characteristic information is provided by the genuine note determination unit 135 to the control unit 137, the control unit 137 provides this information to the control device 16 together with information (machine data) indicating the control unit's own installation position.

A control unit 151 of the control device 16 controls an encryption processing unit 152 to encrypt suspect data and installation position information provided by a dispensing machine 13, and provides the encrypted information to the hall control server 11. Also, when the control unit 151 is provided with an encrypted update program from the hall control server 11, the control unit 151 controls the encryption processing unit 152 to decrypt the update program, and provide the update program to the dispensing machine 13. The control unit 137 updates the update program provided by the control device 16 to be the new genuine note determination program recorded in the genuine note determination program memory 136.

The configuration of the prepaid card sales machine 14 and the change machine 15 is the same as that of the dispensing machine 13, apart from issuing prepaid cards or issuing change in accordance with the value of the notes inserted in the case of the operation unit 138 of the dispensing machine 13, so the explanation is omitted. Also, otherwise there are no other points of difference except the operation of the operation unit 138 referred to above, so the explanation of the dispensing machine 13 can be substituted for the explanation of the prepaid card sales machine 14 and the change machine 15.

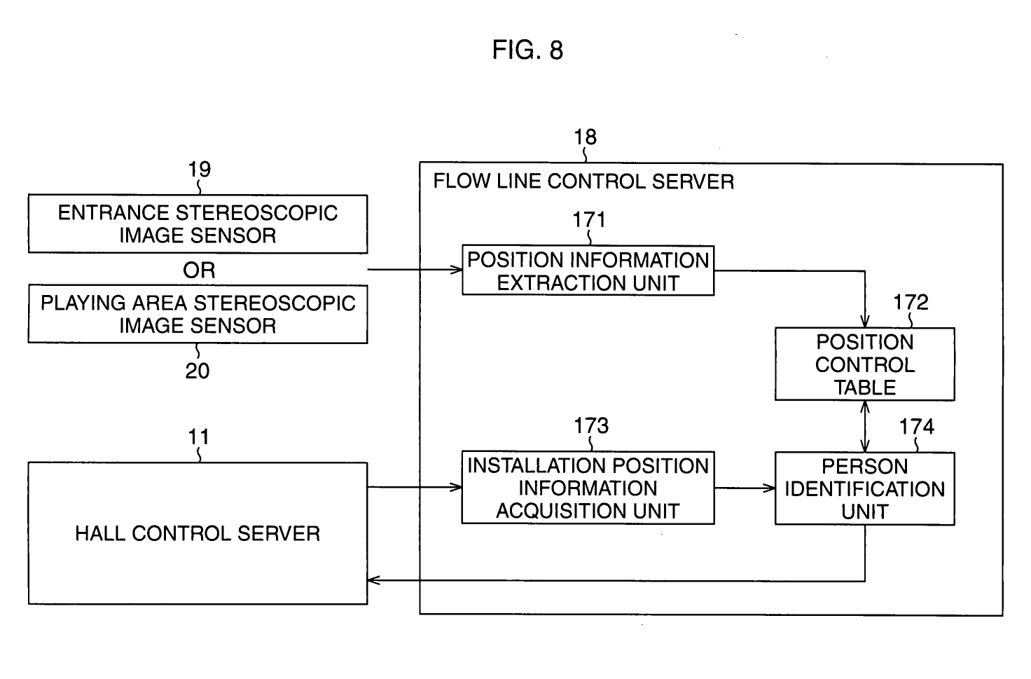

Next, the configuration of the flow line control server 18 according to an embodiment will be explained by reference to FIG. 8.

A position information extraction unit 171 acquires player ID and corresponding information on position within the amusement hall provided by the entrance stereoscopic image sensors 19 or the playing area stereoscopic image sensors 20, and records this information together with their time information in a position control table 172.

An installation position information acquisition unit 173 acquires the installation position of dispensing machines 13, the prepaid card sales machine 14, or the change machine 15 at which a suspect note has been detected from the hall control server 11, and provides the information to a person identification unit 174. Based on the information on installation position of the dispensing machine 13, prepaid card sales machine 14, or change machine 15 at which a suspect note was detected provided by the installation position information acquisition unit 173, the person identification unit 174 refers to the position control table 172, identifies the person that used the suspect note, and provides the present position corresponding to the person ID of the identified person to the hall control server 11.

More specifically, the person identification unit 174 looks up the position information and time information for each person recorded in the position control table 172, based on the provided information on installation position for the dispensing machine 13, the prepaid card sales machine 14, or the change machine 15 at which a suspect note was used and the time information for the detected suspect note, and determines the person ID of the person that is consistent with this information. Furthermore, the person identification unit 174 reads the current location of the determined person ID, and provides this information to the hall control server 11.

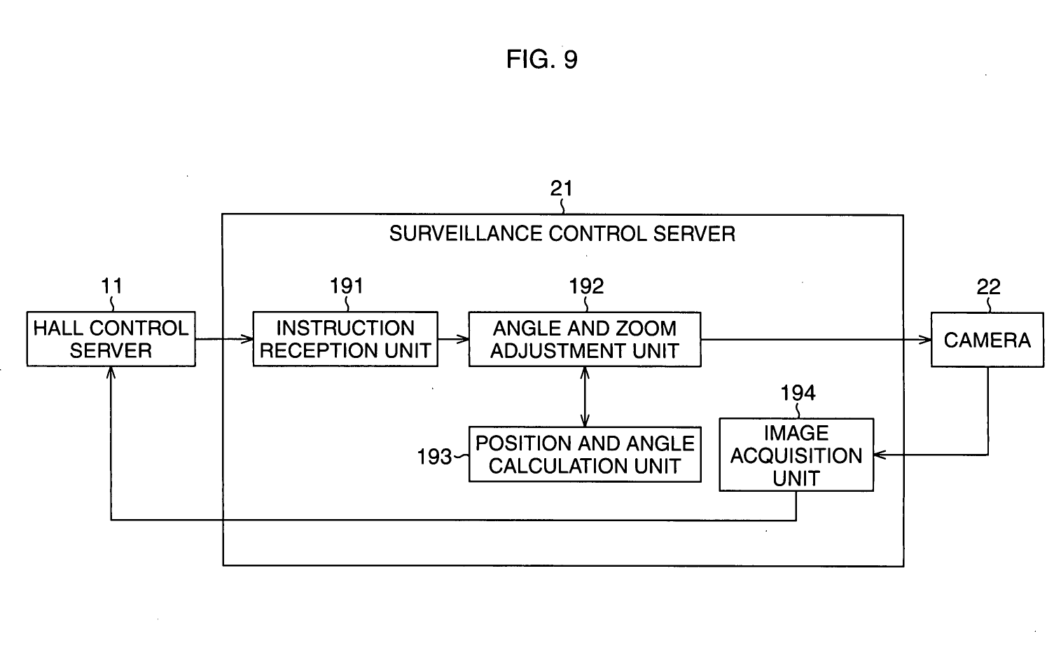

Next the configuration of the function of the surveillance control server 21 according to an embodiment will be explained by reference to FIG. 9.

When an instruction reception unit 191 receives a surveillance imaging instruction from the hall control server 11, the instruction reception unit 191 extracts the position information contained in the surveillance imaging instruction, and provides the information to an angle and zoom adjustment unit 192. The angle and zoom adjustment unit 192 provides the position information to a position and angle calculation unit 193, which calculates a suitable angle and zoom ratio for taking the image of the area indicated by the position information provided (in which the player that used the suspect note is supposed to be), in accordance with the imaging capability of the camera 22. The angle and zoom adjustment unit 192 controls the camera 22 based on the image angle and zoom ratio calculated by the position and angle calculation unit 193 and takes an image the person that used the suspect note.

The camera 22 provides the image data for the image of the person that used the suspect note to an image acquisition unit 194. The image acquisition unit 194 provides the acquired image data of the person that used the suspect note to the hall control server 11.

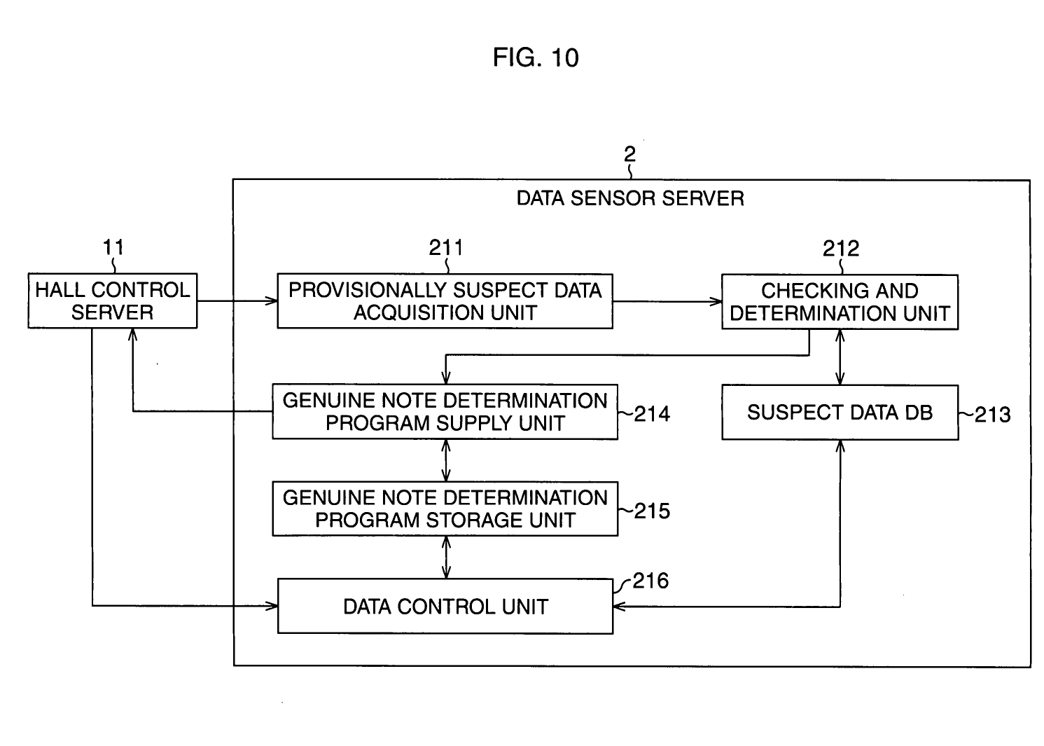

Next, the configuration of the data center server 2 according to an embodiment will be explained by reference to FIG. 10.

A provisionally suspect data acquisition unit 211 acquires provisionally suspect data provided by the hall control server 11, and provides the data to a checking and determination unit 212. The checking and determination unit 212 checks the provisionally suspect data provided by the provisionally suspect data acquisition unit 211 against suspect data already registered in a suspect data DB 213, and determines whether the suspect data matches the registered suspect data. If, for example, there is no matching data the checking and determination unit 212 provides this determination result to a genuine note determination program supply unit 214. At this time the genuine note determination program supply unit 214 notifies the hall control server 11 that there is no matching data. Also, if there is matching suspect data, the checking and determination unit 212 notifies the genuine note determination program supply unit 214 that there is matching data. At this time the genuine note determination program supply unit 214 is provided with information on what suspect data is matching.

The genuine note determination program supply unit 214 reads the genuine note determination program corresponding to the suspect data provided from a genuine note determination program storage unit 215 and provides it to the hall control server 11. When a data control unit 216 is notified by the hall control server 11 that the genuine note determination program has been updated, the data control unit 216 acquires the genuine note determination program that is transmitted at the same time and the corresponding suspect data, and stores them at the genuine note determination program storage unit 215 and the suspect data DB 213 respectively.

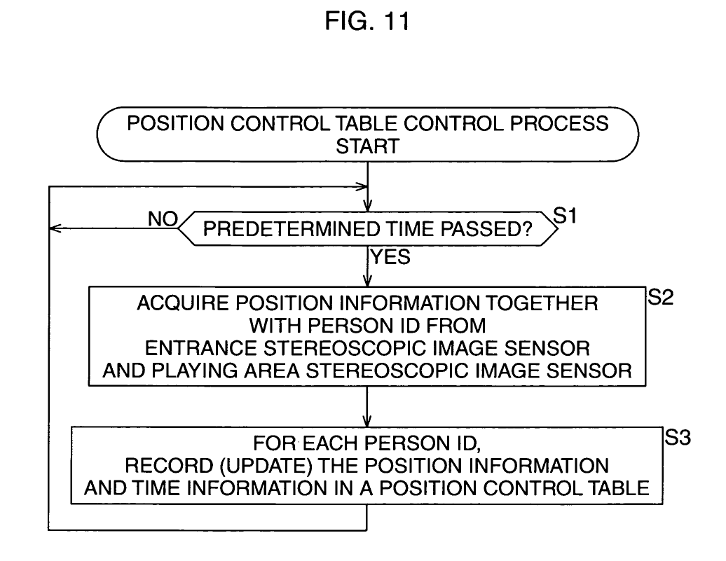

Next, the process of control of the position control table by the flow line control server 18, the entrance stereoscopic image sensors 19, and playing area stereoscopic image sensors 20 is explained by reference to the flowchart in FIG. 11.

In step S1, the position information extraction unit 171 of the flow line control server 18 determines whether a predetermined period of time has passed or not. Until the predetermined period of time has passed the same process is repeated. When for example it is determined that the predetermined period of time has passed the process proceeds to step S2.

In step S2 the position information extraction unit 171 acquires position information (for example three-dimensional position coordinates) together with a person ID from the entrance stereoscopic image sensors 19 or the playing area stereoscopic image sensors 20.

Instep S3, the position information extraction unit 171 records the acquired position information together with the acquired time information corresponding to the person ID in the position control table 172 (position and time information for an already registered person ID is newly added). The process returns to step S1, and thereafter the procedure is repeated.

With the above process the flow line control server 18 can control the position information and corresponding time information for each individual player within the amusement hall 1 for each person ID.

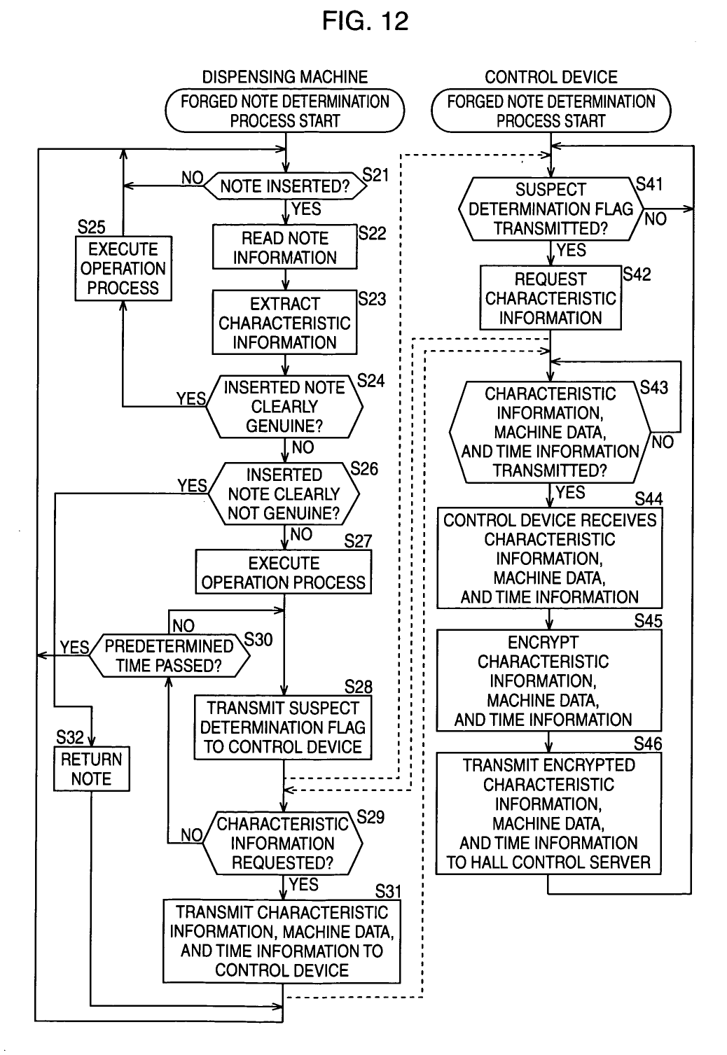

Next the process of determining a forged note by dispensing machine 13 and the control device 16 is explained with reference to the flowchart in FIG. 12.

In step S21, the note insertion and return unit 131 determines whether a note has been inserted or not, and repeats the same process until it is determined that a note has been inserted. For example, in order to use a dispensing machine 13 a player inserts a note, the note insertion and return unit 131 determines that a note has been inserted, and the process proceeds to step S22.

In step S22 the note insertion and return unit 131 provides the inserted note to the note information reading unit 133. The note information reading unit 133 reads for example ink patterns that react with infrared light and patterns recorded in ink that react with magnetism used in printing the note, and provides the information to the characteristic information extraction unit 134.

In step S23, the characteristic information extraction unit 134 extracts the characteristic information from the infrared patterns and magnetic patterns provided by the note information reading unit 133, and provides the characteristic information to the genuine note determination unit 135.

In step S24, the genuine note determination unit 135 determines whether the inserted note is genuine or not, based on the provided characteristic information. More particularly, the genuine note determination unit 135 reads the genuine note determination program recorded in the genuine note determination program memory 136, compares the characteristic information with criterion data, and from the similarity with the criterion data determines whether the inserted note is genuine or not.

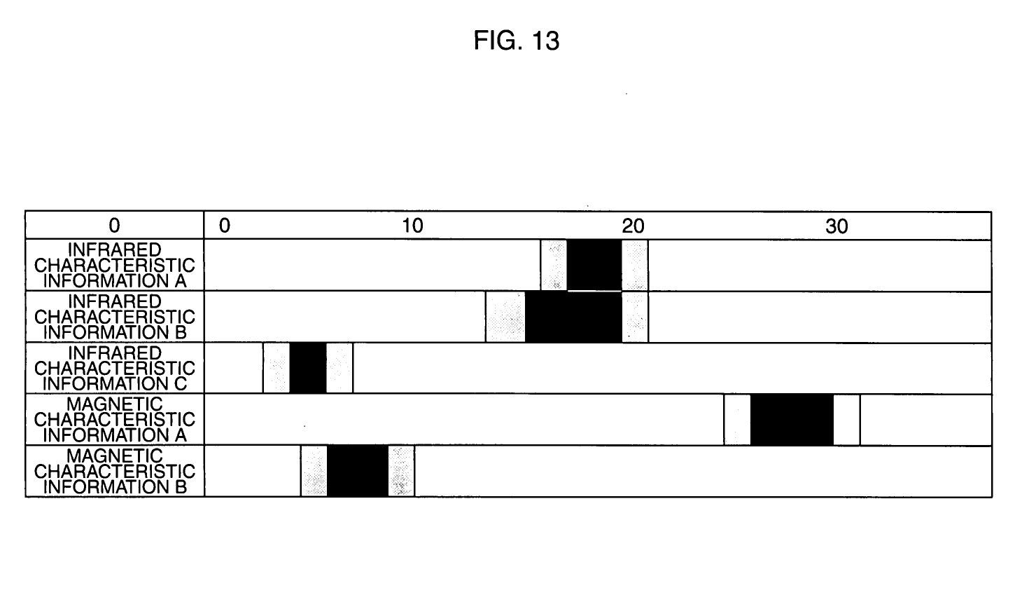

The criterion data could be similar to that shown in FIG. 13, for example. In the explanation of this embodiment a total of five types of characteristic information are assumed: infrared characteristic information A through C read from infrared patterns, and magnetic characteristic information A and B read from magnetic patterns. However, characteristic information other than this characteristic information may be used.

FIG. 13 shows, from the top, infrared characteristic information A through C read from infrared patterns, below which are magnetic characteristic information A and B read from magnetic patterns. In FIG. 13, an example with the level of each characteristic information set within the range 0 to 30 is shown. For each characteristic information the level for which the note is clearly determined to be a genuine note is the range shown in black. The level for which the note is clearly not a genuine note is the range shown in white. Also, the level for which the note cannot be determined to be genuine or not genuine is the range shown in gray.

Therefore, FIG. 13 shows that for infrared characteristic information A, the black colored range around level 20 is the level for which the note is clearly determined to be a genuine note. In the same way, infrared characteristic information B has a broader black range near level 20. Infrared characteristic information C has a black range near level 5, magnetic characteristic information A has a black range near level 30, and magnetic characteristic information B has a black range near level 9. For each these are the levels for which a note is determined to be clearly genuine. Also, on either side of the level that would determine a genuine note is a gray colored range. These are the ranges for which it is not possible to determine whether the note is genuine or not genuine. Also, the white colored ranges are the ranges for which the note is determined to be clearly not genuine.

In other words, in step S24, the genuine note determination unit 135 determines whether the inserted note is genuine or not by determining whether infrared characteristic information A through C and magnetic information A and B are all within the black colored ranges shown in FIG. 13. For example, if in step S24 the inserted note is clearly determined to be a genuine note, in step S25 the genuine note determination unit 135 notifies the operation unit 138 that the note is genuine. As a result, the operation unit 138 dispenses balls or medals corresponding to the amount inserted through a dispensing exit not shown in the drawings. At the same time, the genuine note determination unit 135 controls the note insertion and return unit 131 to accumulate the inserted note in the note accumulation unit 132.

In this way, by determining that the note is genuine the dispensing machine 13 executes a normal ball or medal dispensing process.

On the other hand, in step S24 if the note is not determined to be genuine, in step S26 the genuine note determination unit 135 determines whether the inserted note is clearly not genuine. In other words, the genuine note determination unit 135 determines whether the level of any of infrared characteristic information A through C and magnetic characteristic information A and B are in the white colored area indicated in FIG. 13, and if the other characteristic information is in the white colored region or black colored region, the inserted note is determined to be clearly not a genuine note, and the process proceeds to step S32.

In step S32, the genuine note determination unit 135 controls the note insertion and return unit 131, returns the inserted note, and the process proceeds to step S21.

In other words, when an inserted note is determined to be clearly not genuine, the note is simply returned.

On the other hand, in step S26, if the note is not determined to be clearly not genuine (cannot be determined to be a forgery), in other words if all of infrared characteristic information A through. C and magnetic characteristic information A and B are not in the black region and all are in the black or gray regions, the inserted note cannot be determined to be either a genuine note or a forgery, in step S27 the genuine note determination unit 135 executes the same process as in step S25 and notifies the operation unit 138 to treat the note as if it is a genuine note, although it is not possible to determine whether the inserted note is genuine or not. As a result, the operation unit 138 dispenses balls or medals corresponding to the amount inserted through a dispensing exit not shown in the drawings. At the same time, the genuine note determination unit 135 controls the note insertion and return unit 131 to accumulate the inserted note in the note accumulation unit 132.

In step S28, the genuine note determination unit 135 notifies the control unit 137 that it was not possible to determine whether the inserted note is genuine or not (notifies that a suspect note has been detected), and provides the characteristic information (suspect note characteristic information) used in making the determination to the control unit 137. Based on this notification the control unit 137 transmits a suspect determination flag to the control device 16.

In step S41, the control unit 151 of the control device 16 determines whether a dispensing machine 13 has transmitted a suspect determination flag or not, and repeats this process until a suspect determination flag is transmitted. In step S41, if for example a suspect determination flag is transmitted from step S27, in step S42 the control unit 151 requests from the dispensing machine 13 the characteristic information of the note (suspect note) for which the suspect determination flag has been raised.

In step S29, the control unit 137 of the dispensing machine 13 determines whether characteristic information has been requested or not. If characteristic information has not been requested in step S30 the control unit 137 determines whether a predetermined period of time has passed or not. In step S30, if it is determined that the predetermined period of time has not passed, the process returns to step S28. In other words, after a suspect determination flag has been transmitted, steps S28 through S30 are repeated for a predetermined period of time until a request for characteristic information is received from the control device 16. In step S30, if it is determined that the predetermined period of time has passed, the process returns to step S21. In other words, in this case the suspect determination flag could not be transmitted to the control device 16, so the suspect note is treated as if it were a genuine note and the process again returns to the original step.

On the other hand, in step S29, if for example characteristic information is requested from step S42, in step S31 the control unit 137 provides the control device 16 the suspect note characteristic information provided by the genuine note determination unit 135, together with the machine data of the game machine 12 to which the dispensing machine 13 is associated and time information, and the process returns to step S21.

In step S43, the control unit 151 determines whether the suspect note characteristic information together with the machine data of the game machine 12 with which the dispensing machine 13 is associated and time information have been transmitted or not, and repeats the same process until the information is transmitted. In step S43, if for example the suspect note characteristic information together with the machine data of the game machine 12 with which the dispensing machine 13 is associated and time information have been transmitted by the process in step S31, in step S44 the control unit 151 receives the characteristic information together with the machine data of the game machine 12 with which the dispensing machine 13 is associated and time information.

In step S44, the control unit 151 controls the encryption processing unit 152 to encrypt the received characteristic information together with the machine data of the game machine 12 with which the dispensing machine 13 is associated and time information.

In step S45, the control unit 151 transmits the encrypted characteristic information together with the machine data of the game machine 12 with which the dispensing machine 13 is associated and time information to the hall control server 11.

In the above forged note determination process, if a note is detected for which it is not possible to determine whether it is genuine or not genuine, it is processed as if it is a genuine note. However, the note is regarded as a highly suspect note that is a forgery of a genuine note, and the suspect note characteristic information, machine data of the game machine 12 with which the dispensing machine 13 in which the suspect note was detected is associated and information on the time the suspect note was detected are transmitted to the hall control server 11.

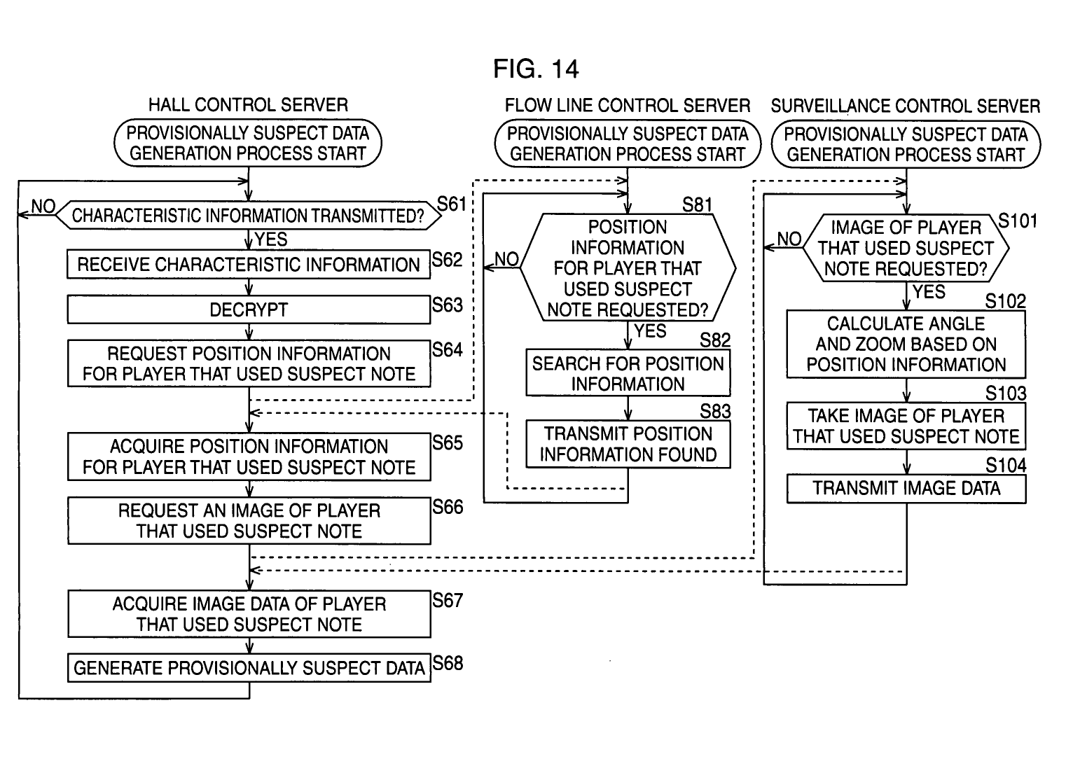

Next, the process of generating provisionally suspect data by the hall control server 11, the flow line control server 18, and the surveillance control server 21 is explained with reference to the flowchart in FIG. 14.

In step S61, the characteristic information acquisition unit 101 determines whether there has been a transmission from the control device 16 or not, and repeats the same process until it is determined that a transmission has arrived. For example, if encrypted characteristic information, machine data for the game machine 12 associated with the dispensing machine 13, and time information is transmitted by the process in step S46 of the flowchart in FIG. 12, the process proceeds to step S62.

In step S62, the characteristic information acquisition unit 101 acquires the transmitted encrypted characteristic information, machine data for the game machine 12 associated with the dispensing machine 13, and time information. In step S63 the characteristic information acquisition unit 101 controls the encryption processing unit 102 to decrypt the information.

In step S64, the characteristic information acquisition unit 101 provides decrypted machine data for the game machine 12 associated with the dispensing machine 13 associated with the characteristic information, and time information to the flow line control server 18, and requests position information for the suspect note that was used. Also, the characteristic information acquisition unit 101 provides the characteristic information to the provisionally suspect data generation unit 106.

In step S81, the installation position information acquisition unit 173 of the flow line control server 18 determines whether position information for a player that has used a suspect note has been requested or not, and repeats the process until a request is received. In step S81, if for example position information for a player that has used a suspect note has been requested by the process in step S64, the process proceeds to step S82.

In step S82, the installation position information acquisition unit 173 provides the machine data and time information transmitted with the request for the position information of the player that used a suspect note to the person identification unit 174. The person identification unit 174 refers to the position control table 172, and searches for the person ID of the player that was at the position of the game machine 12 included in the machine data (the position of the dispensing machine 13 in which the suspect note was detected) at the time indicated by the time information transmitted together with the request for position information. In other words, the person identification unit 174 refers to the position control table 172, and the player that was at the position of the dispensing machine 13 in which the suspect note was used at the time that the suspect note was used is regarded as the person that used the suspect note. By searching for the person ID of that player the player that used the suspect note is identified.

In step S83, the person identification unit 174 reads the current position information for the player corresponding to the person ID identified (found) by referring to the position control table 172, and transmits the person ID to the hall control server 11.

In step S65, the position information acquisition unit 103 acquires the position information from the flow line control server 18 on the player that used the suspect note, and provides the information to the surveillance imaging instruction unit 104.

In step S66, the surveillance imaging instruction unit 104 provides the acquired position information for the player that used the suspect note to the surveillance control server 21, together with an instruction to take an image of the player that used the suspect note.

In step S101, the instruction reception unit 191 of the surveillance control server 21 determines whether an instruction to take an image of a player that used a suspect note has been received from the hall control server 11 or not, and repeats the process until taking an image has been instructed. In step S101, if for example an instruction to take an image of a player that used a suspect note has been received together with position information from the process in step S66, the process proceeds to step S102.

In step S102, the instruction reception unit 191 provides the transmitted position information to the angle and zoom adjustment unit 192. The angle and zoom adjustment unit 192 controls the position and angle calculation unit 193, and based on the position information provided by the instruction reception unit 191 the position and angle calculation unit 193 calculates the optimum imaging angle and zoom ratio for the camera 22 for taking an image of the area corresponding to the position information provided (where the player that used the suspect note is supposed to be).

In step S103, the angle and zoom adjustment unit 192 adjusts the camera 22 to the angle calculated by the position and angle calculation unit 193, and sets the zoom ratio, and takes an image of the player that used the suspect note. The camera 22 provides the image taken to the image acquisition unit 194.

Instep S104, the image acquisition unit 194 transmits the image taken by the camera 22 to the hall control server 11.

In step S67, the image data acquisition unit 106 acquires the image data transmitted by the surveillance control server 21, and provides the data to the provisionally suspect data generation unit 106.

In step S68, the provisionally suspect data generation unit 106 generates provisionally suspect data, based on the suspect note characteristic information provided by the characteristic information acquisition unit 101 and the image data for the player that used the suspect note provided by the image data acquisition unit 105.

By the above provisionally suspect data generation process, when a suspect note has been detected by the forged note determination process explained by reference to FIG. 12, provisionally suspect data is generated based on the characteristic information of the suspect note and the image data taken for the player that used the suspect note. As a result, when it is discovered that a suspect note has been used, it is possible to identify the player that used the suspect note. Therefore when the suspect note is an illegal forgery the origin of the suspect note can be quickly found. Also, when a suspect note is used an image is taken of the player that used the suspect note, so this can be a deterrent to the illegal use of illegal notes.

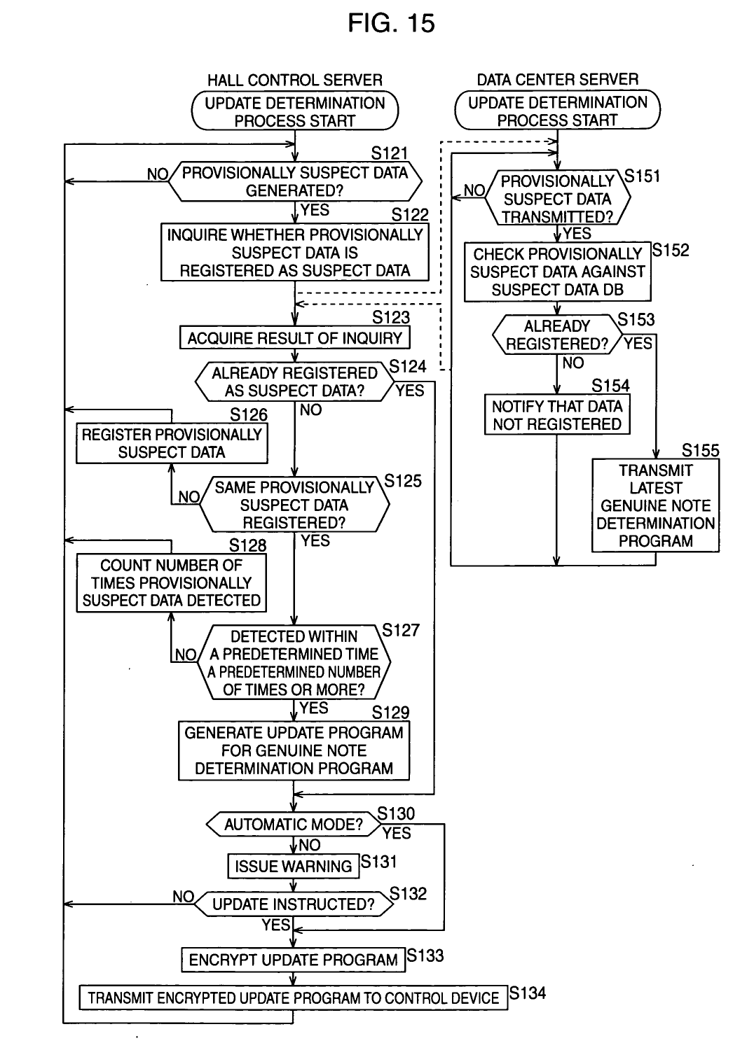

Next, the update determination process for determining whether to update the genuine note determination program used in the forged note determination process or not, based on provisionally suspect data generated in the process described above will be described, by reference to the flowchart shown in FIG. 15.

In step S121, the provisionally suspect data generation unit 106 determines whether provisionally suspect data has been generated or not, and repeats the process until provisionally suspect data is generated (until the provisionally suspect data is generated by the unit itself). For example, if provisionally suspect data is generated (generated by the provisionally suspect data generation unit 106 itself) by the provisionally suspect data generation process explained in the flowchart of FIG. 14, the process proceeds to step S122.

In step S122, the provisionally suspect data generation unit 106 transmits the generated suspect data to the genuine note determination program update determination unit 107 and the data center server 2. When transmitting provisionally suspect data to the data center server 2, the provisionally suspect data generation unit 106 inquires whether the same suspect data has been detected at other amusement halls or not.

In step S151, the provisionally suspect data acquisition unit 211 of the data center server 2 determines whether provisionally suspect data has been transmitted or not, and repeats the process until a transmission is received. For example, if provisionally suspect data is transmitted by the process in step S122, in step S152 the provisionally suspect data acquisition unit 211 acquires the transmitted provisionally suspect data, and provides the data to the checking and determination unit 212. The checking and determination unit 212 compares the suspect note characteristic information contained in the provisionally suspect data provided with the suspect note characteristic information registered in the suspect data DB 213.

Instep S153, the checking and determination unit 212 determines whether the characteristic information included in the transmitted provisionally suspect data is registered as the characteristic information of a suspect note in the suspect data DB 213 or not. In other words, the checking and determination unit 212 determines whether the characteristic information is registered characteristic information.

In step S153, if for example the transmitted provisionally suspect data is not registered, in step S154 the checking and determination unit 212 notifies the genuine note determination program supply unit 214 that the transmitted provisionally suspect data is not registered. The genuine note determination program supply unit 214 notifies the hall control server 11 that the result of the inquiry is that the transmitted suspect data is not registered.

In step S123, the genuine note determination program update determination unit 107 acquires the inquiry result transmitted from the data center server 2.

In step S124, the genuine note determination program update determination unit 107 determines whether the result of the inquiry is that the provisionally suspect data is registered or not. If an inquiry result indicating that the data is not registered is transmitted by the process in step S154, in step S125 the genuine note determination program update determination unit 107 determines whether the same characteristic information of the suspect note contained in the provisionally suspect data is registered in its own suspect data memory 108.

In step S125, if it is determined that the data is not registered, in step S126 the genuine note determination program update determination unit 107 registers the provisionally suspect data provided by the provisionally suspect data generation unit 106 as suspect data in the suspect data memory 108, and the process returns to step S121.

On the other hand, in step S125, if it is determined that the same suspect data is registered, in step S127, the genuine note determination program update determination unit 107 confirms the registration status of the same suspect data, and inquires whether within a predetermined period of time the number of detections is equal to or greater than a predetermined number of times. For example, it is determined whether within a predetermined period of time the number of detections is equal to or greater than a predetermined number of times, such as five or more times per hour a suspect note provided with the same suspect data (characteristic information) is detected, five or more times per day a suspect note provided with the same suspect data (characteristic information) is detected, five or more times per week a suspect note provided with the same suspect data (characteristic information) is detected.

In step S127, if the same suspect data is not detected the prescribed number of times or more within the prescribed period time, in step S128 the genuine note determination program update determination unit 107 increments the suspect data count for the provisionally suspect data by one, records the provisionally suspect data in the suspect data memory 108, and the process returns to step S121.

In step S127, if it is determined that the same suspect data was detected the predetermined number of times or more within the predetermined period of time, in step S129 the genuine note determination program update determination unit 107 regards the provisionally suspect data of the note that was detected as a suspect note as actually suspect. In other words, the data is regarded as suspect data containing characteristic information of a forged note made to resemble a genuine note. The genuine note determination program update determination unit 107 provides the characteristic information of the note contained in the suspect data to the update program generation unit 109, which generates an update program for the genuine note determination program corresponding to the characteristic information. The update program generation unit 109 provides the generated update program to the genuine note determination program update unit 110 and the genuine note determination program update confirmation unit 113. An update program for the genuine note determination program indicates for example a genuine note determination program that can respond to an altered state of the criterion data shown in FIG. 13. In other words, changing the genuine note determination program is the same as changing the criterion data ranges for each characteristic data that determine that a note is genuine (the black colored ranges in the diagram), that a note is not genuine (the white colored ranges in the diagram), and that the note cannot be determined to be either genuine or not genuine (the gray colored ranges in the diagram).

In step S130, the genuine note determination program update unit 110 reads the update mode recorded in the mode memory 110a, to determine whether it is automatic or not. For example, if the update mode is not automatic, in step S131 the genuine note determination program update unit 110 controls the warning generation unit 111 to send a message that an update program for the genuine note determination program has been generated to the mobile terminal 23 possessed by the staff of the amusement hall 1.

In step S132, the genuine note determination program update unit 110 determines whether update of the genuine note determination program has been instructed by the process in step S131. If it is determined that an update has not been instructed, the process proceeds to step S121. In other words, update using the update program by the staff has not been instructed, the genuine note determination program update unit 110 discards the update program generated, and returns to the original process.

In step S132, if it is determined that an update has been instructed, in step S133 the genuine note determination program update unit 110 controls the encryption processing unit 112 to encrypt the genuine note determination program update program provided by the update program generation unit 109.

In step S134, the genuine note determination program update unit 110 transmits the encrypted genuine note determination program update program to the control device 16, and the process returns to step S121.

On the other hand, if in step S130 the update mode is determined to be automatic, the processes in steps S131 and S132 are skipped. In other words, a message is not sent to the mobile terminal 23 possessed by the staff of the amusement hall 1, the generated update program is encrypted and transmitted to the control device 16.

Furthermore, if it is determined in step S153 that the suspect data is already registered, the checking and determination unit 212 notifies the genuine note determination program supply unit 214 that the transmitted provisionally suspect data is already registered. The genuine note determination program supply unit 214 notifies the hall control server 11 that the result of the inquiry is that the transmitted provisionally suspect data is registered. In addition, the genuine note determination program supply unit 214 reads the genuine note determination program update program corresponding to the suspect data from the genuine note determination program storage unit 215, and provides the program to the hall control server 11.

As a result, in step S123, the inquiry result that the suspect data is registered is acquired, and the genuine note determination program update program is acquired.

In response to this, in step S124 it is determined that the suspect data is registered, and steps S125 through S129 are skipped. If the mode is automatic the genuine note determination program transmitted by the data center server 2 is encrypted and transmitted to the control device 16. If the mode is not automatic, in other words if the mode is manual, in response to an instruction from the staff the program is encrypted and transmitted to the control device 16.

According to the above process, if the same provisionally suspect data for a suspect note is detected at another amusement hall 1, and if the corresponding genuine note determination program update program is stored at the data center served 2, and when the data center server 2 regards an update to the genuine note determination program as necessary, the update program is provided. Also, even if the suspect note has not been detected at another amusement hall 1, if the number of times the suspect note is detected within a predetermined period of time within the amusement hall 1 is equal to or greater than a predetermined number, the hall control server 11 itself determines that an update is necessary, and an update program can be generated.

As a result, even if forged notes are used in the same or a different amusement hall 1, these forged notes can be detected as suspect notes, and if the number of times the notes are detected within a predetermined period of time is equal to or greater than a predetermined number of times the genuine note determination program can be updated, so the repeated use of forged notes can be prevented.

In the above example, in the process of step S127, an example is given in which the genuine note determination program is updated if the number of times the suspect data is detected within a predetermined period of time is equal to or greater than a predetermined number. However other conditions may be set, for example the genuine note determination program may be updated if the number of times a suspect note is detected within the same premises is equal to or greater than a predetermined number. Or the genuine note determination program may be updated if the number of times a suspect note is detected within a single playing area installation is equal to or greater than a predetermined number.

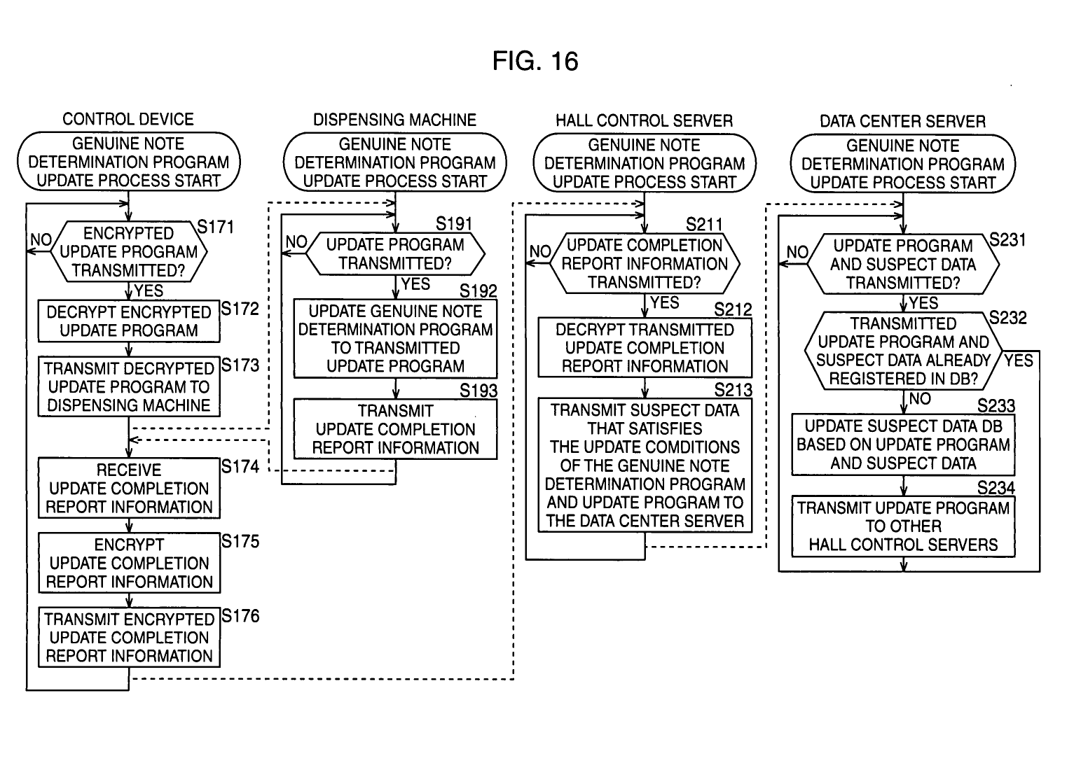

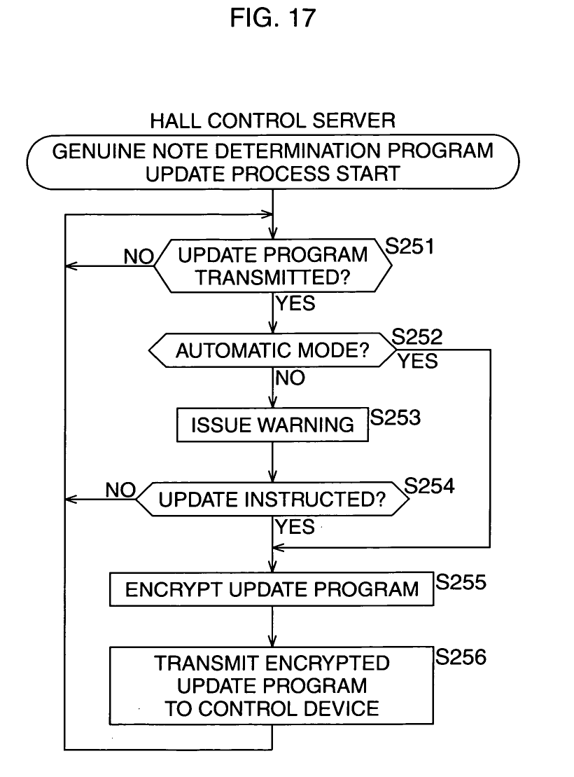

Next, the genuine note determination program updating process is explained with reference to the flowchart in FIGS. 16 and 17. Steps S252 through S256 in the flowchart in FIG. 17 are the same processes as steps S130 through S134 in the flowchart of FIG. 16, so their explanation is omitted for convenience.

In step S171, the control unit 151 of the control device 16 determines whether an encrypted genuine note determination program update program has been transmitted to the control device 16 or not, and repeats the same process until a program is transmitted. For example, if it is determined that an encrypted genuine note determination program update program has been transmitted by the process in step S134 explained by reference to the flowchart in FIG. 15, the process proceeds to step S172.

In step S172, the control unit 151 receives the transmitted encrypted genuine note determination program update program, and controls the encryption processing unit 152 to decrypt the program, and transmits the decrypted program to the dispensing machines 13.

In step S191, the control unit 137 of the dispensing machine 13 determines whether a genuine note determination program update program has been transmitted to it or not, and repeats the process until a program is transmitted to it. For example, if it is determined that a genuine note determination program update program has been transmitted by the process in step S173, the process proceeds to step S192.

In step S192, the control unit 137 overwrites the genuine note determination program recorded in the genuine note determination program memory 136 with the transmitted genuine note determination program, to update the genuine note determination program.

In step S193, the control unit 137 transmits report information to the control device 16 indicating that updating the genuine note determination program has been completed.

In step S174, the control unit 151 of the control device 16 receives the report information indicating completion of updating transmitted by the dispensing machine 13.

In step S175, the control unit 151 controls the encryption processing unit 152, and encrypts the completion of updating report information, and in step S176 the encrypted report information is transmitted to the hall control server 11.

In step S211, the genuine note determination program update confirmation unit 113 determines whether encrypted updating completion report information from the control device 16 has been transmitted to it or not, and repeats the process until the information is transmitted.

In step S211, if for example encrypted updating completion report information has been transmitted by the process of step S176, in step S212 the genuine note determination program update confirmation unit 113 controls the encryption processing unit 114 to decrypt the encrypted report information.

In step S213, the genuine note determination program update confirmation unit 113, as a condition for updating the genuine note determination program, reads the suspect data from the suspect data memory 108, and transmits the suspect data together with the update program provided by the update program generation unit 109 to the data center server 2.

Instep S231, the data control unit 216 of the data center server 2 determines whether an update program and the corresponding suspect data have been transmitted or not, and repeats the process until the program and data are transmitted. For example, if a genuine note determination program update program and the corresponding suspect data were transmitted by the process in step S213, the process proceeds to step S232.

In step S232, the data control unit 216 refers to the genuine note determination program supply unit 215 and suspect data DB 213, to determine whether the transmitted update program and suspect data are registered or not.

In step S232, if for example both the transmitted update program and the suspect data are not registered, in step S233 the data control unit 216 registers the transmitted update program and suspect data in the genuine note determination program storage unit 215 and suspect data DB 213 respectively.

In step S234, the data control unit 216 transmits the update program to the hall control server 11 of a different amusement hall 1 from the hall control server 11 that that transmitted both the update program and the suspect data, and the process proceeds to step S231.

Also, in step S232, if both the transmitted update program and suspect data are registered, the processes of steps S233 and S234 are skipped, and the process proceeds to step S231.

In step S251 (FIG. 17), the genuine note determination program update unit 110 of the hall control server 11 of an amusement hall 1 different from the hall control server 11 that transmitted the update program and suspect data determines whether an update program has been transmitted by the data center server 2, and repeats the process until a program is transmitted. For example if an update program has been transmitted by the process in step S234 (FIG. 16), the process proceeds to step S252.

According to the above processes, when a genuine note determination program update program is generated by either the data center server 2 or the hall control server 11, the genuine note determination programs of both are updated, so if a forged note is used it is possible to update the genuine note determination program of both as a measure against the suspect note, and the repeated use of illegal notes is prevented. Furthermore, by updating the genuine note determination program of the data center server 2 it is possible to update the genuine note determination program of the hall control server 11 of every amusement hall 1 connected to the data center server 2, so it is possible to prevent the repeated use of forged notes in a plurality of amusement halls 1.

According to the above, it is possible to accurately take an image of and record an illegal player that uses a forged note in an amusement hall as well as dynamically change the genuine note determination program used for determining whether a note is genuine or not in accordance with the occurrence of suspect notes. Therefore, surveillance for the use of forged notes based on the genuine note determination program and rapid updating of the genuine note determination program is possible.

However, the series of surveillance processes described above are executed by hardware, but they can also be executed by software. If the series of processes are executed by software, the programs comprising the software are installed from recording media to a computer incorporating special hardware or for example a commercial personal computer capable of executing many types of function by installing many types of program.

As shown in FIG. 5, the recording media are separate from the hall control server 11, and can include not only removable media including package media containing magnetic disks 61 (including flexible disks), optical disks 62 ((Compact Disc-Read Only Memory (CD-ROM), Digital versatile Disc (DVD)), magneto-optical disks 63, semiconductor memory 64, or similar on which programs are recorded and distributed to provide programs to users, but can also include ROM 42 on which programs are recorded or hard disks containing memory 48 and so on that are provided to users incorporated in advance into a computer.

In this specification, the steps describing programs recorded on recording media are not necessarily processed as a time series in the stated order, but may be processed in parallel or individually.

Also, in this specification, system refers to the overall device that includes several devices.

1. A genuine note determination system comprising a first information processing device that distinguishes genuine notes, a second information processing device that accumulates position information for players that enter an amusement hall, and a third information processing device that takes images of the players based on the position information of the second information processing device, the genuine note determination system further comprising:
note insertion means that receives notes inserted by the players;
extraction means that extracts characteristic information of the note inserted in the note insertion means;
genuine note determination means that determines whether the note is genuine or whether the note is not genuine based on the characteristic information;
position information acquisition means that acquires the position of the players as position information;
accumulation means that accumulates the position information acquired by the position information acquisition means for each player; and
imaging means that takes images of an area corresponding to the position information of the player that inserted the note in the note insertion means from among the position information accumulated by the accumulation means when the determination result of the genuine note determination means is neither that the note is genuine nor that the note is not genuine.

2. The genuine note determination system according to claim 1, wherein the first information processing device that distinguishes genuine notes is a value media processing device, the second information processing device that accumulates position information for players that enter an amusement hall is a flow line control server, and the third information processing device that takes images of the players based on the position information of the second information processing device is a surveillance control server.

3. The genuine note determination system according to claim 2, wherein the value media processing device comprises:
note insertion means that receives notes inserted by the players;
extraction means that extracts characteristic information of the note inserted in the note insertion means; and
genuine note determination means that determines whether the note is genuine or whether the note is not genuine based on the characteristic information;
the flow line control server comprises:
position information acquisition means that acquires the position of the players as position information; and
accumulation means that accumulates the position information acquired by the position information acquisition means for each player; and
the surveillance control server comprises:
imaging means that takes images of an area corresponding to the position information of the player that inserted the note in the note insertion means from among the position information accumulated by the accumulation means when the determination result of the genuine note determination means is neither that the note is genuine nor that the note is not genuine.

4. The genuine note determination system according to claim 1, wherein the genuine note determination means determines whether the note is genuine or whether the note is not genuine by comparing the characteristic information with criterion information that indicates whether the note is genuine or whether the note is not genuine.

5. The genuine note determination system according to claim 1, further comprising a fourth information processing device that generates update information for the criterion information.

6. The genuine note determination system according to claim 5, wherein the fourth information processing device is a hall control server which comprises:
update determination means that determines whether to update the criterion information based on the characteristic information extracted by the extraction means and images taken by the imaging means; and
update criterion information generation means that generates update criterion information by updating the criterion information based on the characteristic information; and
the value media processing device further comprising:
update means that updates the criterion information to the updated criterion information.

7. The genuine note determination system according to claim 1, further comprising a fifth information processing device that accumulates characteristic information extracted by the extraction means and images taken by the imaging means of a plurality of genuine note determination systems.

8. The genuine note determination system according to claim 7, wherein the fifth information processing device is a data center server which comprises:
accumulation means that accumulates characteristic information extracted by the extraction means and images taken by the imaging means of the plurality of genuine note determination systems; and
accumulation determination means that determines whether characteristic information extracted by the extraction means and images taken by the imaging means of the genuine note determination system are already accumulated in the accumulation means, wherein based on the determination result of the accumulation determination means regarding the characteristic information extracted by the extraction means and the images taken by the imaging means, the update determination means determines whether to update the criterion information or not.

9. The genuine note determination system according to claim 8, wherein when the number of times that the accumulation determination means determines that the characteristic information extracted by the extraction means and the images taken by the imaging means are not registered within a predetermined period of time is greater than a predetermined number, the update determination means determines to update the criterion information.

10. The genuine note determination system according to claim 8, wherein when the criterion information is updated to updated criterion information by the update means, the accumulation means accumulates the characteristic information extracted by the extraction means, the images taken by the imaging means, and the updated criterion information.

11. The genuine note determination system according to claim 8, wherein if the accumulation determination means determines that the characteristic information extracted by the extraction means and images taken by the imaging means of the genuine note determination system have already been accumulated by the accumulation means, the update means updates the updated criterion information, as the criterion information, corresponding to the characteristic information extracted by the extraction means and the images taken by the imaging means of the genuine note determination system that are determined to be already accumulated.

12. A genuine note determination method for a genuine note determination system including a first information processing device that distinguishes genuine notes, a second information processing device that accumulates position information for players that enter an amusement hall, and a third information processing device that takes images of the players based on the position information of the second information processing device, the method comprising:
a note inserting step of receiving notes inserted by the players;
an extracting step of extracting characteristic information for the note inserted in the note inserting step;
a genuine note determining step of determining whether the note is genuine or whether the note is not genuine based on the characteristic information;
a position information acquiring step of acquiring the position of the players as position information;
an accumulating step of accumulating the position information acquired in the position information acquiring step for each player; and
an image taking step of taking images of an area corresponding to the position information of the player that inserted the note in the note inserting step from among the position information accumulated in the accumulating step, when the result in the genuine note determination step is neither that the note is genuine nor that the note is not genuine.

13. A program that causes a computer to execute a process, the computer controlling a genuine note determination system that includes a first information processing device that distinguishes genuine notes, a second information processing device that accumulates position information for players that enter an amusement hall, and a third information processing device that takes images of the players based on the position information of the second information processing device, and the process comprising:
a note inserting step of receiving a note inserted by a player;
an extracting step of extracting characteristic information for the note inserted in the note inserting step;
a genuine note determining step of determining whether the note is genuine or whether the note is not genuine based on the characteristic information;
a position information acquiring step of acquiring the position of the players as position information;
an accumulating step of accumulating the position information acquired in the position information acquiring step for each player; and
an image taking step of taking images of an area corresponding to the position information of the player that inserted the note in the note inserting step from among the position information accumulated in the accumulating step, when the result in the genuine note determination step is neither that the note is genuine nor that the note is not genuine.

14. A value media processing device, comprising:
note insertion means that receives notes inserted by players;
extraction means that extracts characteristic information of the note inserted in the note insertion means; and
genuine note determination means that determines whether the inserted note is genuine or whether the note is not genuine based on the characteristic information.

15. A method of operating a value media processing device, comprising:
a note inserting step of receiving a note inserted by a player;
an extraction step of extracting characteristic information of the note inserted in the note inserting step; and
a genuine note determination step of determining whether the note is genuine or whether the note is not genuine based on the characteristic information.

16. A program that causes a computer to execute a process which comprises:
a note inserting step of receiving a note inserted by a player;
an extraction step of extracting characteristic information of the note inserted in the note inserting step; and
a genuine note determination step of determining whether the note is genuine or whether the note is not genuine based on the characteristic information.

17. A flow line control server, comprising:
position information acquisition means that acquires the position of players as position information; and
accumulation means that accumulates the position information acquired by the position information acquisition means for each player.

18. A flow line control method for a flow line control server, comprising:
a position information acquiring step of acquiring the position of players as position information; and
an accumulating step of accumulating the position information acquired in the position information acquiring step for each player.

19. A program that causes a computer to execute a process which comprises:
a position information acquiring step of acquiring the position of players as position information; and
an accumulating step of accumulating the position information acquired in the position information acquiring step for each player.

20. A surveillance control server, comprising:
imaging means that takes images of an area corresponding to the position information of a player when a note inserted by the player is neither genuine nor not genuine based on characteristic information of the note.

21. A surveillance control method for a surveillance control server, comprising:
an image taking step of taking images of an area corresponding to the position information of a player when a note inserted by the player is neither genuine nor not genuine based on characteristic information of the note.

22. A program that causes a computer to execute a process which comprises:
an image taking step of taking images of an area corresponding to the position information of a player when a note inserted by the player is neither genuine nor not genuine based on characteristic information of the note.

23. A hall control server, comprising:
update determination means that determines whether to update criterion information that indicates whether the characteristic information of a note inserted by a player is genuine or not genuine, based on the characteristic information of the note and images taken of the player; and
update criterion information generation means that generates updated criterion information by updating the criterion information based on the characteristic information.

24. A hall control method for a hall control server, comprising:
an update determining step of determining whether to update criterion information that indicates whether the characteristic information of a note inserted by a player is genuine or not genuine, based on the characteristic information of the note and images taken of the player; and
an update criterion information generating step of generating updated criterion information by updating the criterion information based on the characteristic information.

25. A program causes a computer to execute a process which comprises:
an update determining step of determining whether to update criterion information that indicates whether the characteristic information of a note inserted by a player is genuine or not genuine, based on the characteristic information of the note and images taken of the player; and
an update criterion information generating step of generating updated criterion information by updating the criterion information based on the characteristic information.

26. A data center server, comprising:
accumulation means that accumulates characteristic information extracted from notes in a plurality of genuine note determination systems and images taken of players that inserted the notes; and
accumulation determination means that determines whether the characteristic information extracted from the note and the image taken of the player are already accumulated in the accumulation means.

27. A method of operating a data center server, comprising:
an accumulating step of accumulating characteristic information extracted from notes in a plurality of genuine note determination systems and images taken of players that inserted the notes; and
an accumulation determination step of determining whether the characteristic information extracted from the note and the image taken of the player are already accumulated in the accumulation step.

28. A program that causes a computer to execute a process which comprises:
an accumulating step of accumulating characteristic information extracted from notes in a plurality of genuine note determination systems and images taken of players that inserted the notes; and
an accumulation determination step of determining whether the characteristic information extracted from the note and the image taken of the player are already accumulated in the accumulation step.

29. The genuine note determination system according to claim 2, wherein the genuine note determination means determines whether the note is genuine or whether the note is not genuine by comparing the characteristic information with criterion information that indicates whether the note is genuine or whether the note is not genuine.

30. The genuine note determination system according to claim 3, wherein the genuine note determination means determines whether the note is genuine or whether the note is not genuine by comparing the characteristic information with criterion information that indicates whether the note is genuine or whether the note is not genuine.

31. The genuine note determination system according to claim 2, further comprising a fourth information processing device that generates update information for the criterion information.

32. The genuine note determination system according to claim 3, further comprising a fourth information processing device that generates update information for the criterion information.

33. The genuine note determination system according to claim 4, further comprising a fourth information processing device that generates update information for the criterion information.

34. The genuine note determination system according to claim 2, further comprising a fifth information processing device that accumulates characteristic information extracted by the extraction means and images taken by the imaging means of a plurality of genuine note determination systems.

35. The genuine note determination system according to claim 3, further comprising a fifth information processing device that accumulates characteristic information extracted by the extraction means and images taken by the imaging means of a plurality of genuine note determination systems.

36. The genuine note determination system according to claim 6, further comprising a fifth information processing device that accumulates characteristic information extracted by the extraction means and images taken by the imaging means of a plurality of genuine note determination systems.
